(19) United States
(12) Patent Application Publication
(10) Pub. No.: US 2010/0056392 A1
(43) Pub. Date: Mar. 4, 2010

(54) MICROSTRUCTURE AND MICRODOMAIN MICROARRAYS, METHODS OF MAKING SAME AND USES THEREOF

(76) Inventors: Matthew Greving, Phoenix, AZ (US); Neal Woodbury, Tempe, AZ (US); Trent R. Northen, San Diego, CA (US)

Correspondence Address: WILMERHALE/BOSTON, 60 STATE STREET, BOSTON, MA, 02109, US

(21) Appl. No.: 11/917,406

(22) PCT Filed: Jun. 15, 2006
(86) PCT No.: PCT/US2006/023344

§ 371 Date: Nov. 9, 2009

Related U.S. Application Data
(60) Provisional application No. 60/691,308, filed on Jun. 15, 2005.

(51) Int. Cl. C40B 30/10; C40B 40/00; C40B 50/00; C40B 30/00; C40B 50/18; C08F 118/02

(52) U.S. Cl. 506/12; 506/13; 506/30; 506/7; 506/32; 521/149; 526/319

(57) ABSTRACT

Disclosed are methods for direct characterization of microdomains and/or three-dimensional microstructure arrays bearing high densities of reactive sites using Matrix Assisted Laser Desorption Ionization Time of Flight Mass Spectrometery (MALDI-MS) and other analytical techniques. The high site density of the arrays can provide sufficient sample of each array element and/or materials bound to each element to obtain directly using common analytical techniques such as MALDI-MS. Spatially directed synthesis of heteropolymers is done through the use of pliotolabile, electrically labile, and chemically labile protecting group(s).

### CROSS-REFERENCE TO RELATED APPLICATIONS

This application claims the benefit of priority to U.S. Provisional Application No. 60/691,308, filed Jun. 15, 2005, which is incorporated by reference herein in its entirety.

### ACKNOWLEDGEMENTS

The research leading to this invention was funded in part by the Department of Energy by grant no. DE-FCS36-05GO15016 and the National Science Foundation by grant no. CHE-0131222. The U.S. Government may have certain rights in this invention.

### BACKGROUND

Microarrays are commonly used in the analysis of an analyte, or a mixture of analytes, for the purposes of identification and quantification, as well as to characterize physical and chemical properties. Microarrays can be used to determine the chemical composition, molecular structure, and properties of the analyte(s). For example, microarrays are often used to determine the presence of a specific compound or, in the case of DNA arrays, a microarray can be used to identify the presence or amount of specific gene transcripts or other specific nucleic acid sequences.

Microarrays are typically fabricated on a substrate that can comprise, for example, a silanized glass surface. Reactive chemicals or materials are then disposed on the substrate in a monolayer at a number of different sites by some patterned chemical or physical process, such as photolithography. Each monolayer element in the array has known reactive properties designed to bond or combine with a specific target chemical or molecular structure. Each reactive monolayer element can be selected or designed to interact with a specific target analyte. The interaction or reaction facilitates molecular recognition of the analyte. When exposed to various analytes, the reactive materials in the array elements bond or combine with the target analyte, which chemically modifies the microarray. The microarray can then be studied with analysis tools to see which element(s) reacted and thereby ascertain the composition or presence of the analyte(s).

Microarrays are often constructed through sequential positioning of specific deprotections, removing the protective groups from the reactive sites, followed by subsequent modification with chemical groups. Microarrays have used reactive sites with photolabile protective groups such as nitroveratryloxycarbonyl (NVOC) to synthesize arrays of peptides on a glass substrate. In other microarrays, the reactive sites are protected with photolabile groups such as (α-methyl-o-nitropiperonyl)oxy)carbonyl) (MeNPOC) to synthesize DNA arrays on glass substrates. Other microarrays are constructed by spotting materials of interest in specific positions on reactive silanized glass.

A known characterization technique used in DNA arrays is the hybridization of fluorescence probes and use of a scanning epifluorescent microscope to detect such probes. A fluorescently labeled complimentary strand can be made for each array element making it possible to characterize any DNA microarray under the appropriate hybridization conditions.

In any case, the density of reactive sites on the monolayer surface of a microarray is very low, e.g., 10-30 picomoles/cm². The signals from such microarrays, which are typically fluorescence, are weak and require sensitive detection equipment. The low signal strength attributed to the low concentration of reactive sites on the monolayer surface of the microarray makes detection and analysis of the analyte difficult, and may require use of sophisticated and expensive equipment.

The low concentration of reactive sites on typical microarrays is also problematic for micoroarrays used to synthesize biopolymers. As with microarrays used for analyte detection, a significant disadvantage of microarrays used for spatially resolved synthesis is the limited number of reactive sites available on the glass surface (McGall estimates 10-30 picomole/cm²). Characterization of reaction products becomes very difficult, requiring sensitive techniques and instruments.

Many methods have been explored for efficient and robust spatially resolved synthesis with microarrays. For example, photopolymer photoresists have been used for many years to create small features in the microelectronics industry and they have been used in rapid prototyping or stereo lithography (Rabek, Mechanisms of photophysical processes and photochemical reactions in polymers, John Wiley and Sons Ltd., New York, 1987). Most recently, photopolymers have been used in conjunction with high numerical aperture lenses and multiphoton excitation to create very small three-dimensional objects. For example, Kawata et al. has used single and multi photon interferential patterning to generate features as small as 50 nm (Advanced Materials 15:2011-2014, 2003). Kawata et al. has also created submicron objects using photopolymers in conjunction with two-photon excitation (Nature 412:697-698, 2001). Maruo et al. has used single photon excitation to create 430 nm photopolymer features (Sensors and Actuators 100:70-76).

Spatially resolved biopolymer synthesis has been used to synthesize DNA arrays on glass substrates (Fodor et al., Science 251:767-773, 1999). Also, U.S. Pat. No. 5,405,783 used photolithography in combination with a nitroveratryloxycarbonyl (NVOC) photolabile protective group to synthesize arrays of peptides on a glass substrate. McGall et al. used photolithography in combination with the 5-((methyl-2-nitropiperonyloxy)carbonyl) (MeNPOC) to synthesize DNA arrays on glass substrates (J. Am. Chem. Soc. 119:5081-5090, 1997). Sussman et al. used micromirror arrays in conjunction with the MeNPOC protective group to synthesize DNA microarrays (Nature Biotechnology 117:974-978). Cagney et al. discussed different applications of protein and peptide arrays (Nature Biotechnology, 18:393-339, 2000).

Solid Phase Synthesis (SPS) is a method of choice for synthesizing biopolymers such as peptides, DNA, etc. Merrifield first synthesized a tetrapeptide on a solid resin particle polystyrene (J. Am. Chem. Soc. 85:2149-2154, 1963). Barany et al. synthesized a solid phase resin that swells in both water and organic solvents using various methacrylate resins (J. Am. Chem. Soc. 118:7083-7093, 1996). Frechet et al. used photolithography to prepare monolithic polymers in a spatially defined manner in glass capillaries (J. Polymer Sci. Pt. A 40:755-769, 2002; Macromolecules 36:1677-1684, 2003).

Solid phase synthesis techniques have also been used to generate combinatorial libraries. These methods typically include dividing the SPS beads into pools after each synthesis step to generate large libraries of peptides. The peptide can be screened and cleaved from the bead or can be encoded with some sort of tag for identification (Lam, Chem. Rev. 411-448, 1997—this is the so called “One-Bead-One-Compound” method).

In light of the continuing interest to synthesize and analyze numerous compositions (e.g., biopolymers) and to prepare libraries of such compositions, what is needed are new compositions and methodologies for synthesizing and characterizing such compositions. The articles, methods, and compositions disclosed herein meet these and other needs.

### SUMMARY

In accordance with the purposes of the disclosed materials, compounds, compositions, articles, devices, and methods, as embodied and broadly described herein, the disclosed subject matter, in one aspect, relates to compounds and compositions and methods for preparing and using such compounds and compositions. In a further aspect, disclosed herein are methods of synthesizing a biopolymer (e.g., peptide, carbohydrate, DNA, RNA) array on porous polymer materials. In still further aspects, disclosed herein are methods for direct characterization of three-dimensional arrays using analytical techniques such as MALDI-TOF mass spectrometry and fluorescence spectroscopy, where the array is comprised of a photopolymer bearing a reactive group.

Additional advantages will be set forth in part in the description that follows, and in part will be obvious from the description, or can be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### DESCRIPTION OF THE FIGURES

The accompanying figures, which are incorporated in and constitute a part of this specification, illustrate several aspects described below.

FIG. 1 is a pair of SEM images of a photopolymer microstructure constructed from solid phase synthesis resin suspended in a monomer/photoinitator solution: (Left) one microstructure, (Right) surface of the solid phase synthesis resin.

FIG. 2 is a pair of in situ MALDI-MS spectra from an array of microstructures: (Top) A photopatterned feature indicates the presence of the TMPP-GGFL-amide peptide (964.4 Da), which is not seen in the unpatterned control microstructures.

FIG. 3 is a pair of SEM images of microstructures resulting from the direct formation of solid phase synthesis microstructures: (Left) one microstructure showing the pattern of mirrors and the number ‘2’; (Right) view of the porous composition of the microstructure.

FIG. 4 shows in situ MALDI-MS for SPS microstructures: (Top) overall mass spectrum and (Bottom) comparison of experimental vs. predicted isotopic distribution. This demonstrates the in situ characterization of an unlabeled heteropolymer array using MALDI-MS.

FIG. 5 is an in situ MALDI-MS sequence determination from SPS microstructures. Post source decay reveals the formation of secondary ions, corresponding to the TMPP-GGF, TMPP-GG, and TMPP-G.

FIG. 6 (Top) is a picture showing a microstructure array with light illumination Note the bright TNBS stained structure (bottom) fluorescence emission from hybridized DNA labeled with Texas RedX dye.

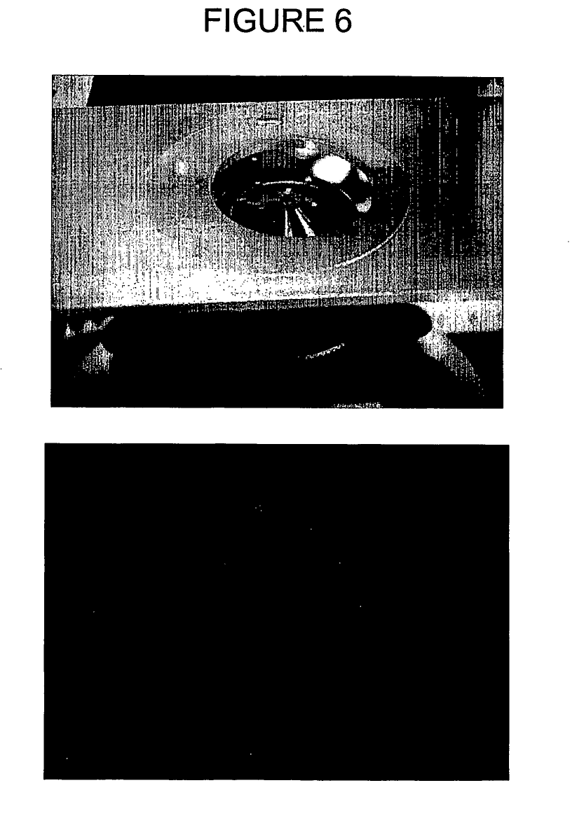

FIG. 7 shows MALDI-MS spectra from tryptic digest of proteins bound to consensus DNA covalently bound to polymer microstructures. Peptides were found only on structures treated with the DNA and not with the control.

FIG. 8 is an illustration of the in situ substitution approach to array construction. (Top) Moving from left to right, photolabile protective group is removed from peptides on selected microstructures followed by coupling of a Fmoc-amino acids. (Bottom) This is repeated until the appropriate Fmoc-amino acids have been coupled to the entire surface at which point the Fmoc group is removed and the photolabile group is attached.

FIG. 9 is a SEM image of photopolymer microstructure array. Elements are 75 μm in diameter and 500 μm apart and 100 μm tall.

FIG. 10 is a SEM image of one thin microstructure at three different magnifications and reveals macroporous structure.

FIG. 11 is a typical colored photoproduce seen as a result of MeNPOC, NVOC, and in this case photocleavage of NNPOC-Trp. (Left) unexposed microstructures and (Right) microstructures exposed for 10 minutes to 365 nm light in 10% TFA in acetonitrile.

FIG. 12 is a photograph of bromophenol blue stained microstructure array after exposure for various times.

FIG. 13 is an illustration of the four light directed synthesis steps (1-4) were used to generate the four peptides YGL, YGFL, YGGL, and YGGFL. Shaded areas (Left) correspond to areas that were not illuminated and each of the four colored areas (Right) corresponds to a given different peptide.

FIG. 14 is a chart showing bromophenol blue monitoring of selected light directed peptide synthesis steps on three microstructures. (A) corresponds to YGL, (B-C) to YGGL (synthesis proceeding left to right). Note the slight decrease in color between the first two Fmoc steps indicating some stepwise losses. Also note the selective patterning of MeNPOC GL to selectively add glycine to two elements (inside box) and not the third.

FIG. 15 is in situ MALDI MS spectra showing correct ions for each of the four peptides in the array (A) TMPP-YGL 923.52 Da vs. 923.38 Da predicted and TMPPX(tbut)GL 979.65 Da vs. 979.45 predicted; (B) TMPP-YGFL 1070.58 Da vs. 1070.45 Da predicted; (C) TMPP-YGGFL 980.88 Da vs. 980.41 Da predicted; (D) TMPP-YGGFL 1127.54 Da vs. 1127.47 Da predicted.

FIG. 16 shows a 5 micron resolution image of Cy5-GAL80 binding to 8,000 unique peptide microdomains attached to a porous polymer surface in a 100×80 feature array format. Each peptide microdomain contains a unique peptide sequence and has a diameter of approximately 50 microns and is surrounded by a less polar acylated porous polymer surface.

FIG. 17 (Inset for FIG. 16) shows the template peptide sequence at the top of the figure with variable positions indicated as brackets. Substitutions in variable position { }c are shown as blocks in the top image, substitutions in variable positions { }a and { }b are shown as rows and columns respectively in an enlarged view of one of the { }c substitution blocks.

### DETAILED DESCRIPTION

The materials, compounds, compositions, articles, devices, and methods described herein may be understood more readily by reference to the following detailed description of specific aspects of the disclosed subject matter and the Examples included therein and to the Figures.

Before the present materials, compounds, compositions, articles, devices, and methods are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### DEFINITIONS

In this specification and in the claims that follow, reference will be made to a number of terms that shall be defined to have the following meanings:

Throughout the specification and claims the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an array” includes mixtures of two or more such agents, reference to “the polymer” includes mixtures of two or more such polymers, and the like.

In this specification and in the claims that follow, the term “heteropolymer” can refer to any serially assembled molecule or molecular system.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value,” and possible ranges between values are also disclosed, as appropriately understood by the skilled artisan. For example, if the value “10” is disclosed, then “less than or equal to 10” as well as “greater than or equal to 10” is also disclosed. It is also understood that throughout the application data are provided in a number of different formats and that these data represent endpoints and starting points and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

As used herein, the term “substituted” is contemplated to include all permissible substituents of organic compounds. In a broad aspect, the permissible substituents include acyclic and cyclic, branched and unbranched, carbocyclic and heterocyclic, and aromatic and nonaromatic substituents of organic compounds. Illustrative substituents include, for example, those described below. The permissible substituents can be one or more and the same or different for appropriate organic compounds. For purposes of this disclosure, the heteroatoms, such as nitrogen, can have hydrogen substituents and/or any permissible substituents of organic compounds described herein which satisfy the valences of the heteroatoms. This disclosure is not intended to be limited in any manner by the permissible substituents of organic compounds. Also, the terms “substitution” or “substituted with” include the implicit proviso that such substitution is in accordance with permitted valence of the substituted atom and the substituent, and that the substitution results in a stable compound, e.g., a compound that does not spontaneously undergo transformation such as by rearrangement, cyclization, elimination, etc.

“A¹,” “A²,” “A³,” and “A⁴” are used herein as generic symbols to represent various specific substituents. These symbols can be any substituent, not limited to those disclosed herein, and when they are defined to be certain substituents in one instance, they can, in another instance, be defined as some other substituents.

The term “alkyl” as used herein is a branched or unbranched saturated hydrocarbon group of 1 to 40 carbon atoms, such as methyl, ethyl, n-propyl, isopropyl, n-butyl, isobutyl, s-butyl, t-butyl, n-pentyl, isopentyl, s-pentyl, neopentyl, hexyl, heptyl, octyl, nonyl, decyl, dode cyl, tetradecyl, hexadecyl, eicosyl, tetracosyl, and the like. The alkyl group can also be substituted or unsubstituted. The alkyl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein. A “lower alkyl” group is an alkyl group containing from one to six carbon atoms.

Throughout the specification “alkyl” is generally used to refer to both unsubstituted alkyl groups and substituted alkyl groups; however, substituted alkyl groups are also specifically referred to herein by identifying the specific substituent(s) on the alkyl group. For example, the term “halogenated alkyl” specifically refers to an alkyl group that is substituted with one or more halide, e.g., fluorine, chlorine, bromine, or iodine. The term “alkoxyalkyl” specifically refers to an alkyl group that is substituted with one or more alkoxy groups, as described below. The term “alkylamino” specifically refers to an alkyl group that is substituted with one or more amino groups, as described below, and the like. When “alkyl” is used in one instance and a specific term such as “alkylalcohol” is used in another, it is not meant to imply that the term “alkyl” does not also refer to specific terms such as “alkylalcohol” and the like.

This practice is also used for other groups described herein. That is, while a term such as “cycloalkyl” refers to both unsubstituted and substituted cycloalkyl moieties, the substituted moieties can, in addition, be specifically identified herein; for example, a particular substituted cycloalkyl can be referred to as, e.g., an “alkylcycloalkyl.” Similarly, a substituted alkoxy can be specifically referred to as, e.g., a “halogenated alkoxy,” a particular substituted alkenyl can be, e.g., an “alkenylalcohol,” and the like. Again, the practice of using a general term, such as “cycloalkyl,” and a specific term, such as “alkylcycloalkyl,” is not meant to imply that the general term does not also include the specific term.

The term “cycloalkyl” as used herein is a non-aromatic carbon-based ring composed of at least three carbon atoms. Examples of cycloalkyl groups include, but are not limited to, cyclopropyl, cyclobutyl, cyclopentyl, cyclohexyl, norbornyl, and the like. The term “heterocycloalkyl” is a type of cycloalkyl group as defined above, and is included within the meaning of the term “cycloalkyl,” where at least one of the carbon atoms of the ring is replaced with a heteroatom such as, but not limited to, nitrogen, oxygen, sulfur, or phosphorus. The cycloalkyl group and heterocycloalkyl group can be substituted or unsubstituted. The cycloalkyl group and heterocycloalkyl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “polyalkylene group” as used herein is a group having two or more CH₂ groups linked to one another. The polyalkylene group can be represented by the formula —(CH₂)ₐ—, where “a” is an integer of from 2 to 500.

The term “alkoxy” as used herein is an alkyl or cycloalkyl group bonded through an ether linkage; that is, an “alkoxy” group can be defined as —OA¹ where A¹ is alkyl or cycloalkyl as defined above. “Alkoxy” also includes polymers of alkoxy groups as just described; that is, an alkoxy can be a polyether such as —OA¹-OA² or —OA¹—(OA²)ₐ-OA³, where “a” is an integer of from 1 to 200 and A¹, A², and A³ are alkyl and/or cycloalkyl groups.

The term “alkenyl” as used herein is a hydrocarbon group of from 2 to 40 carbon atoms with a structural formula containing at least one carbon-carbon double bond. Asymmetric structures such as (A¹A²)C═C(A³A⁴) are intended to include both the E and Z isomers. This may be presumed in structural formulae herein wherein an asymmetric alkene is present, or it may be explicitly indicated by the bond symbol C═C. The alkenyl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkenyl” as used herein is a non-aromatic carbon-based ring composed of at least three carbon atoms and containing at least one carbon-carbon double bound; i.e., C═C. Examples of cycloalkenyl groups include, but are not limited to, cyclopropenyl, cyclobutenyl, cyclopentenyl, cyclopentadienyl, cyclohexenyl, cyclohexadienyl, norbornenyl, and the like. The term “heterocycloalkenyl” is a type of cycloalkenyl group as defined above, and is included within the meaning of the term “cycloalkenyl,” where at least one of the carbon atoms of the ring is replaced with a heteroatom such as, but not limited to, nitrogen, oxygen, sulfur, or phosphorus. The cycloalkenyl group and heterocycloalkenyl group can be substituted or unsubstituted. The cycloalkenyl group and heterocycloalkenyl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “alkynyl” as used herein is a hydrocarbon group of 2 to 40 carbon atoms with a structural formula containing at least one carbon-carbon triple bond. The alkynyl group can be unsubstituted or substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol, as described herein.

The term “cycloalkynyl” as used herein is a non-aromatic carbon-based ring composed of at least seven carbon atoms and containing at least one carbon-carbon triple bound. Examples of cycloalkynyl groups include, but are not limited to, cycloheptynyl, cyclooctynyl, cyclononynyl, and the like. The term “heterocycloalkynyl” is a type of cycloalkenyl group as defined above, and is included within the meaning of the term “cycloalkynyl,” where at least one of the carbon atoms of the ring is replaced with a heteroatom such as, but not limited to, nitrogen, oxygen, sulfur, or phosphorus. The cycloalkynyl group and heterocycloalkynyl group can be substituted or unsubstituted. The cycloalkynyl group and heterocycloalkynyl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein.

The term “aryl” as used herein is a group that contains any carbon-based aromatic group including, but not limited to, benzene, naphthalene, phenyl, biphenyl, phenoxybenzene, and the like. The term “aryl” also includes “heteroaryl,” which is defined as a group that contains an aromatic group that has at least one heteroatom incorporated within the ring of the aromatic group. Examples of heteroatoms include, but are not limited to, nitrogen, oxygen, sulfur, and phosphorus. Likewise, the term “non-heteroaryl,” which is also included in the term “aryl,” defines a group that contains an aromatic group that does not contain a heteroatom. The aryl group can be substituted or unsubstituted. The aryl group can be substituted with one or more groups including, but not limited to, substituted or unsubstituted alkyl, cycloalkyl, alkoxy, alkenyl, cycloalkenyl, alkynyl, cycloalkynyl, aryl, heteroaryl, aldehyde, amino, carboxylic acid, ester, ether, halide, hydroxy, ketone, azide, nitro, silyl, sulfo-oxo, or thiol as described herein. The term “biaryl” is a specific type of aryl group and is included in the definition of “aryl.” Biaryl refers to two aryl groups that are bound together via a fused ring structure, as in naphthalene, or are attached via one or more carbon-carbon bonds, as in biphenyl.

The term “aldehyde” as used herein is represented by the formula —C(O)H. Throughout this specification “C(O)” is a short hand notation for a carbonyl group, i.e., C═O.

The terms “amine” or “amino” as used herein are represented by the formula NA¹A²A³, where A¹, A², and A³ can be, independently, hydrogen or substituted or unsubstituted alkyl, cycloalkyl, alkenyl, cycloalkenyl, alkynyl, cycloalkynyl, aryl, or heteroaryl group as described herein.

The term “carboxylic acid” as used herein is represented by the formula —C(O)OH.

The term “ester” as used herein is represented by the formula —OC(O)A¹ or —C(O)OA¹, where A¹ can be a substituted or unsubstituted alkyl, cycloalkyl, alkenyl, cycloalkenyl, alkynyl, cycloalkynyl, aryl, or heteroaryl group as described herein. The term “polyester” as used herein is represented by the formula -(A¹O(O)C-A²-C(O)O)ₐ— or -(A¹O(O)C-A²-OC(O))ₐ—, where A¹ and A² can be, independently, a substituted or unsubstituted alkyl, cycloalkyl, alkenyl, cycloalkenyl, alkynyl, cycloalkynyl, aryl, or heteroaryl group described herein and “a” is an integer from 1 to 500. “Polyester” is as the term used to describe a group that is produced by the reaction between a compound having at least two carboxylic acid groups with a compound having at least two hydroxyl groups.

The term “ether” as used herein is represented by the formula A¹OA², where A¹ and A² can be, independently, a substituted or unsubstituted alkyl, cycloalkyl, alkenyl, cycloalkenyl, alkynyl, cycloalkynyl, aryl, or heteroaryl group described herein. The term “polyether” as used herein is represented by the formula -(A¹O-A²O)ₐ—, where A¹ and A² can be, independently, a substituted or unsubstituted alkyl, cycloalkyl, alkenyl, cycloalkenyl, alkynyl, cycloalkynyl, aryl, or heteroaryl group described herein and “a” is an integer of from 1 to 500. Examples of polyether groups include polyethylene oxide, polypropylene oxide, and polybutylene oxide.

The term “halide” as used herein refers to the halogens fluorine, chlorine, bromine, and iodine.

The term “hydroxyl” as used herein is represented by the formula —OH.

The term “ketone” as used herein is represented by the formula A¹C(O)A², where A¹ and A² can be, independently, a substituted or unsubstituted alkyl, cycloalkyl, alkenyl, cycloalkenyl, alkynyl, cycloalkynyl, aryl, or heteroaryl group as described herein.

The term “azide” as used herein is represented by the formula —N₃.

The term “nitro” as used herein is represented by the formula —NO₂.

The term “nitrile” as used herein is represented by the formula —CN.

The term “silyl” as used herein is represented by the formula —SiA¹A²A³, where A¹, A², and A³ can be, independently, hydrogen or a substituted or unsubstituted alkyl, cycloalkyl, alkoxy, alkenyl, cycloalkenyl, alkynyl, cycloalkynyl, aryl, or heteroaryl group as described herein.

The term “sulfo-oxo” as used herein is represented by the formulas —S(O)₂A¹, —S(O)₂A¹, —OS(O)₂A¹, or —OS(O)₂OA¹, where A¹ can be hydrogen or a substituted or unsubstituted alkyl, cycloalkyl, alkenyl, cycloalkenyl, alkynyl, cycloalkynyl, aryl, or heteroaryl group as described herein. Throughout this specification “S(O)” is a short hand notation for S═O. The term “sulfonyl” is used herein to refer to the sulfo-oxo group represented by the formula —S(O)₂A¹, where A¹ can be hydrogen or a substituted or unsubstituted alkyl, cycloalkyl, alkenyl, cycloalkenyl, alkynyl, cycloalkynyl, aryl, or heteroaryl group as described herein. The term “sulfone” as used herein is represented by the formula A¹S(O)₂A², where A¹ and A² can be, independently, a substituted or unsubstituted alkyl, cycloalkyl, alkenyl, cycloalkenyl, alkynyl, cycloalkynyl, aryl, or heteroaryl group as described herein. The term “sulfoxide” as used herein is represented by the formula A¹S(O)A², where A¹ and A² can be, independently, a substituted or unsubstituted alkyl, cycloalkyl, alkenyl, cycloalkenyl, alkynyl, cycloalkynyl, aryl, or heteroaryl group as described herein.

The term “thiol” as used herein is represented by the formula —SH.

Unless stated to the contrary, a formula with chemical bonds shown only as solid lines and not as wedges or dashed lines contemplates each possible isomer, e.g., each enantiomer and diastereomer, and a mixture of isomers, such as a racemic or scalemic mixture.

Disclosed herein are materials, compounds, compositions, and components that can be used for, can be used in conjunction with, can be used in preparation for, or are products of the disclosed methods and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a composition is disclosed and a number of modifications that can be made to a number of components of the composition are discussed, each and every combination and permutation that are possible are specifically contemplated unless specifically indicated to the contrary. Thus, if a class of components or moieties A, B, and C are disclosed as well as a class of components or moieties D, E, and F and an example of a composition A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, B, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, steps in methods of making and using the disclosed compositions. Thus, if there are a variety of additional steps that can be performed it is understood that each of these additional steps can be performed with any specific aspect or combination of aspects of the disclosed methods, and that each such combination is specifically contemplated and should be considered disclosed.

Reference will now be made in detail to specific aspects of the disclosed materials, compounds, compositions, articles, and methods, examples of which are illustrated in the accompanying Examples and Figures.

Disclosed herein are microarrays, microstructures, and microdomains, as are described herein, and to methods of preparing and using such structures. For example, disclosed are microarrays that comprise a photopolymer bearing a reactive group and a photolabile protecting group(s), and solid-phase synthesis methodology involving such arrays. As is described herein, one can prepare small, three-dimensional structures that can be functionalized in spatially defined ways for the construction of sensors, catalysis, materials (including biological and nonbiological), drug delivery, molecular evolution, etc.

Microarrays with Microstructures

A microarray, comprising a substrate; and plurality of three-dimensional microstructures formed on the substrate, each three-dimensional microstructure being made with polymer material and having a plurality of reactive sites formed on a surface of the three-dimensional microstructure. A polymer gel or macroporous polymer (rigid or gel) can be used. The porous polymer material is porous on all or part of the surface of the three-dimensional microstructure. The key is the capability of providing a high number of accessible internal reactive sites. The majority of the reactive sites are present on the interior of the polymer material.

The three-dimensional microstructure can increase surface area and density of the reactive sites on the surface of the three-dimensional microstructure. The microarray of can have dimensions of less than about 1 mm. The microarray can have reactive sites present in a surface density of from about 100 cm-2 to about 106 cm-2.

The microarray further comprises a plurality of chemical groups, respectively, attached to the reactive sites on the surface of the three-dimensional microstructure, each chemical group including at least one monomer. The microarray can have a first one of the plurality of chemical groups having a first chemical structure and a second one of the plurality of chemical groups having a second chemical structure different from the first chemical structure. The first chemical structure can have an affinity for a first analyte and the second chemical structure can have an affinity for a second analyte.

In one aspect, the plurality of chemical groups can comprise two or more microdomains, wherein a first one of the microdomains comprises a first plurality of chemical groups having a first chemical structure, and wherein a second one of the microdomains comprises a second plurality of chemical groups having a second chemical structure different from the first chemical structure.

In the micro array, a microchannel can be formed around at least one of the plurality of three-dimensional microstructures.

Methods of Making Microarrays with Microstructures

Provided is a method of making a microarray, comprising the steps of: providing a substrate; and disposing a plurality of three-dimensional microstructures on the substrate, each three-dimensional microstructure being made with polymer material and having plurality of reactive sites formed on a surface of the three-dimensional microstructure.

In the method, the disposing step can comprise at least one of photolithography, electropolymerization, spotting, stamping, printing, or selective polymerization or a combination thereof.

In the method, the three-dimensional microstructure increases surface area and density of the plurality of reactive sites on the surface of the three-dimensional microstructure.

In the method, one type of polymer material is polymer gel, another is porous on all or part of the surface of the three-dimensional microstructure.

The method can further comprise attaching a plurality of chemical groups, respectively, to the reactive sites on the surface of the three-dimensional microstructure, each chemical group including at least one monomer.

The method can further comprise the steps of: attaching on a reactive site a first one of the plurality of chemical groups with a first chemical structure; and attaching on a further reactive site a second one of the plurality of chemical groups with a second chemical structure.

The method can further comprise the step of forming a microchannel around at least one of the plurality of three-dimensional microstructures.

Microarrays with Microdomains

Provided is a microarray, comprising: a substrate; a plurality of microdomains formed on the substrate, each microdomain being made with polymer material and having a plurality of reactive sites formed on a surface of the microdomain; and an interstitial region surrounding each microdomain.

The microdomain microarray can comprise reactive sites present in a surface density of from about 100 cm⁻² to about 106 cm⁻². In the microdomain microarray, the majority of the reactive sites can be present on the interior of the polymer material. In the microdomain microarray, the interstitial regions can comprise physical barriers. In other embodiments the interstitial regions have differential surface reactivity. The microdomain microarray can have interstitial regions comprising at least one of glass, silanized glass, silicon, silanized silicon, metal, porous or nonporous polymers, cells, tissues, or a mixture thereof. The interstitial region can form a virtual well by using nonpolar groups in interstitial areas to prevent wetting by polar fluids. The interstitial region can form a virtual well by using polar groups in interstitial areas to prevent wetting by nonpolar fluids.

In the microdomain microarray, the interstitial region can act as a buffer zone to reduce the effects of scattered light, creates a diffusion barrier between the reactive sites of one microdomain and the reactive sites of another microdomain, acts as a chromatography material, scavenges reactive groups produced during synthesis, acts as a calorimetric indicator, acts as a fluorescence quencher, acts as a electrochemical scavenger, or acts as a laser desorption surface, or a combination thereof. Examples of the corresponding materials are provided herein.

In the microdomain microarray, a first one of the plurality of microdomains can comprise a first plurality of chemical groups having a first chemical structure, and a second one of the plurality of microdomains can comprise a second plurality of chemical groups having a second chemical structure different from the first chemical structure. The microdomain microarray can further comprise a plurality of chemical groups, respectively, attached to the reactive sites on the surface of the microdomains, each chemical group including at least one monomer. In the microdomain microarray, a first one of the plurality of chemical groups can have a first chemical structure and a second one of the plurality of chemical groups can have a second chemical structure.

In the microdomain microarray, the porous polymer material can increase surface area of the microdomains and density for the reactive sites on the surface of the microdomains. One type of porous polymer material is porous polymer gel.

In the microdomain microarray, the plurality of microdomains can comprise heteropolymer elements and the interstitial region comprises a nonpolar element. The heteropolymer elements can be peptides attached to a porous polymer and the nonpolar element can be an acylated glycine attached to the same porous polymer film. The heteropolymer elements can be peptides and the nonpolar element can be a fluorinated material.

In one aspect the microdomain microarray, the microdomains can be three-dimensional microstructures.

Methods of Making Microarrays with Microdomains

Provided is a method of making a microarray, comprising the steps of: providing a substrate; disposing a plurality of microdomains on the substrate, each microdomain being made with polymer material and having a plurality of reactive sites formed on the polymer, wherein the reactive sites of the microdomain are surrounded by an interstitial region that lacks reactive sites; and attaching a plurality of chemical groups to the reactive sites, each chemical group including at least one monomer. Optionally a nonpolar material can be bound at the interstitial region.

In the method of making the microdomain microarray, the disposing step can comprise at least one of photolithography, electropolymerization, spotting, stamping, printing, or selective polymerization or a combination thereof.

In the method of making the microdomain microarray, the polymer material can be polymer gel. The polymer material can be porous on all or part of the surface of the three-dimensional microstructure.

The method of making the microdomain microarray can further comprise the steps of: attaching on a reactive site a first one of the plurality of chemical groups with a first chemical structure; and attaching on further reactive site a second one of the plurality of chemical groups with a second chemical structure.

In the method of making the microdomain microarray, the first one of the plurality of chemical groups can be provided in a first microdomain and the second one of the plurality of chemical groups can be provided in a second microdomain that is different from the first microdomain.

The method of making the microdomain microarray can further comprise the step of forming a microchannel around at least one of the plurality of three-dimensional microstructures.

Methods of Characterization

Provided is a method for characterization of microarrays comprising the steps of: providing a substrate bearing a plurality of microdomains formed on the substrate, each microdomain being made with polymer material and having a plurality of reactive sites formed on the polymer, and wherein at least one of the plurality of microdomains comprises a first plurality of chemical groups having a first chemical structure and bound to at least a portion of the plurality of reactive sites. Optionally the first plurality of chemical groups having a first chemical structure can be contacted with a species having an affinity for the first chemical structure.

Then, at least a portion of the first plurality of chemical groups can be released from the plurality of reactive sites; and the released chemical groups characterized.

In the method using the releasing step, the releasing step can comprise trypsinization.

The characterization method can further comprise the step of analyzing the species having an affinity for the first chemical structure. The method can further comprise the step of analyzing at least a portion of the first plurality of chemical groups prior to the releasing step. The analyzing step can comprise at least one of absorbance spectroscopy, fluorescence spectroscopy, colorimetry, FTIR, RAMAN, SPR, circular dichroism or a combination thereof. The analyzing step can further comprises modification of the chemical groups selected from reaction with a fluorescent tag, reaction with an absorbance tag, reaction with a radiolabeled tag, and reaction with an electrochemical tag. The analyzing step can further comprise modification of the chemical groups selected from reaction with a secondary tag selected from a secondary antibody, a stain, and a ligand that specifically or nonspecifically binds to an analyte.

In the characterization of the microarray, at least a portion of the microdomains can comprise three-dimensional microstructures. In a further embodiment, at least a portion of the microdomains can be positioned on three-dimensional microstructures. Alternatively, two or more microdomains can be positioned on one three-dimensional microstructure.

In the method of characterization of the microarray, the releasing step can be performed with a laser and the characterizing step is performed with mass spectrometry. In the method of characterization of the microarray, the array can be characterized via MALDI-MS. The array can be characterized via multiple analytical techniques. For example, peptide mass finger-printing is used to characterize the array.

For example the array can be characterized via microanalytical devices. The microanalytical device can be a microcantilever.

In the method of characterization of the microarray, the microstructures can comprise at least one polymer. The microstructures can comprise a polymer gel.

MALDI-MS can be used to characterize materials bound or having interacted with the array.

In the method of characterization of the microarray, the chemical groups can comprise at least one of DNA, RNA, aptamers, peptides, proteins, sugars, or are cells.

In the method of characterization of the microarray, the array being analyzed can be made by a photochemical method, an electrochemical method, a chemical method, or by a spotting or printing method. For example, the photochemical method can utilize a solid phase synthesis resin comprising a polymer material having a low fluorescence and low optical absorbance from about 300 nm to about 650 nm and bearing microdomains with interstitial region surrounding each microdomain, or three-dimensional microstructures, or a combination thereof, wherein a plurality of reactive sites is present on each microdomain or microstructure. The resin can produce a polymer material comprising a porous polymer, a crosslinked porous polymer, or a polymer gel. The resin can comprise reactive sites present in a surface density of from about 100 cm-2 to about 106 cm-2. The resin can produce a polymer, wherein the majority of the reactive sites are present on the interior of the polymer material.

In certain examples, the number of reactive sites and overall site density in an array can be increased by many orders of magnitude e.g., 10-fold more than a monolayer, e.g. 100,000, 10,000, due to the availability of reactive sites inside the polymer itself. This can produce a range of densities of 100 picomoles/cm² to 10 micromoles/cm². Array elements can have a density of at least about 100 elements per square cm (that would be one mm on center). For example the array can have at least about 200, 300, 400, 500, 600, 700, 800, 1000 elements per square cm. A lower array element density is also contemplated, e.g., 50 elements/cm. Therefore, in the case of DNA, since a fluorescently labeled complimentary strand can be made for each array element, it is possible to characterize any DNA microarray with the techniques described herein under the appropriate hybridization conditions. Additionally, the increased site density can allow for greater fluorescent intensity, which in turn does not require the expensive optical detection equipment currently used by those skilled in the art and/or can increase the sensitivity of detection.

Furthermore, since peptides are not complimentary like DNA and RNA, fluorescently labeled compliments cannot be used to characterize peptide arrays making characterization of peptide arrays very difficult. Most commonly, the use of antibody systems in which one antibody is labeled with a fluorescent dye and one antibody (could be the same) is specific for the peptide sequence to be probed. This is useful for a proof of principle, but would be impractical for probing large number of peptides.

Even though techniques have evolved to allow the synthesis and screening of libraries using SPS techniques, screening of the beads is complex. The array format allows rapid screening of large libraries in parallel and has proven to be very useful for DNA arrays.

The disclosed methods and compositions combine the benefits of the array format, large number of reactive sites available in porous solid phase synthesis resin, and the ability to form polymer structures using photopolymers resulting in larger signals, and/or improved contrast ratios, and better applicability of analytical characterization techniques.

In many examples described herein, the microstructures are three-dimensional in form, having length, width, and height or depth. The microstructures can be about 10 nm to 10 mm. The three-dimensional nature of the microstructures provides additional surface area upon which to form a higher concentration of reactant molecules as compared to known microarray reactive sites. The higher number of reactant molecules per microarray reactive site increases the visual or instrumentally detectable indicators or molecular properties (i.e., properties of the heteropolymers and or those microstructures to which the incident analytes have or are bonded or interacted). The higher concentration of reactant molecules will cause these sites to be easier to identify, read, quantify and characterize, as compared to two dimensional monolayer arrays. The higher concentration of reactant molecules facilitates the use of many analytical methods to probe the array. In the case of optical approaches, they will emit a higher intensity of light in a fluorescence assay, result in greater signal in a Raleigh or Raman scattering measurement, and provide greater absorbance for an absorbance assay. In addition, there can be greater contrast between reacted sites and adjacent non-reacted sites or for reactant sites with a different composition. The analysis of the reacted microarray is easier to perform and can even be done with the naked eye in the case of changes in fluorescence, absorbance, or scattering in the visible region upon binding. The polymer microstructures can contain polymers that add additional properties such as: electrical conductivity, fluorescent properties, photoresponsive properties, thermally responsive properties, catalytic properties, magnetic properties, ion conducting properties, electrochemical properties, etc.

A powerful aspect of this technology is that it is not limited to biopolymers. It is not limited to polymers at all. Any serially assembled molecular system is possible. It does not have to be in water. It does not have to be done under standard temperatures and pressures. Any solvent, temperature, pressure, pH, salt concentration, etc. that you can do the chemistry of interest can be used.

Heteropolymer arrays of microdomains can be formed on discontinuous or continuous porous polymer films. Here a microdomain is defined as a chemically distinct or chemically modified material surrounded by another chemically distinct or chemically modified material. The surrounding material is referred to as the spacer and the heteropolymer it surrounds is a heteropolymer array element. The area surrounding the heteropolymer array element, referred to as the spacer, can also be referred to as an interstitial area.

In application, the spacer can serve a variety of purposes including: acting as a buffer zone to absorb or otherwise reduce the effects of scattered light, forming a virtual well by preventing wetting (e.g., by using nonpolar groups in interstitial areas), creating a diffusion barrier between heteropolymer array elements, acting as a chromatography material, scavenging reactive groups produced during synthesis, acting as a calorimetric indicator, acting as a fluorescence quencher, acting as a electrochemical scavenger, acting as a laser desorption surface, etc. The microdomain is capable of confining water drops to microstructures based on the differential surface energy between the reactive site area and the interstitial area. A typical example of a microdomain would include but is not limited to, an array of multiple heteropolymer elements attached to a continuous porous polymer film, each surrounded by a chemically distinct spacer. This spacer may be the same for some, all, or none of the elements. Spacers can include, but are not limited to, inorganic materials such as glass, silanized glass, silicon, silanized silicon, metal, porous or nonporous polymers, cells, tissues, etc. Preferred spacers include silanized glass and modified porous polymer films.

For example a microdomain can be comprised of heteropolymer elements attached to the porous polymer film which is surrounded by a porous polymer film with a differential surface energy (e.g., produced by a less polar material). This less polar material can include, but is not limited to, fluorinated materials, aromatic molecules, linear hydrocarbon materials, substituted aromatic molecules, branched hydrocarbons, silanes, thiols, etc. In further examples, where the spacer acts as a reactive group scavenger, the spacer material can be modified by molecules such as reactive nucleophiles (thiols, amines, etc.) to prevent diffusion of chemical species that would react with nucleophiles between microdomain heteropolymer elements. In further examples, where the spacer acts as a reactive group scavenger, the spacer material can be modified by molecules such as bases to that would react with protons produced in the microdomains of heteropolymer elements and prevent diffusion to other microdomains of heteropolymer elements. In further examples, where the spacer acts as a barrier to diffusion, the spacer material can be modified by large molecules or molecular systems that decrease diffusion of solvent and solute molecules between microdomains of heteropolymer elements. In further examples, where the spacer acts as a indicator, the spacer material can be modified by molecules such as pH indicators (for example bromophenol blue) to monitor the pH in the spacer between microdomain heteropolymer elements. In further examples, where the spacer acts as a optical barrier, the spacer material can be modified by molecules such as dyes that absorb light that might otherwise be scattered between microdomain heteropolymer elements.

In one specific embodiment, the heteropolymer elements are peptides attached to a porous polymer and the spacer is an acylated glycine attached to the same porous polymer film. In a most preferred case the heteropolymer elements are peptides and the spacer is a fluorinated or other nonpolar material. The interstitial area can have reactive groups that have been modified (e.g., capped), such that they are not reactive in the same way as the reactive sites. Other examples of heteropolymer elements are described elsewhere herein, and include nucleotides and oligonucleotides.

In the case of a nonpolar material, this can serve a variety of purposes, one of which is to prevent wetting by aqueous solutions. This allows the use of spotting techniques without the risk of mixing between adjacent spots. This allows independent chemical modification of all heteropolymer elements. Typical modifications include, acid or base cleavage of the peptide from the heteropolymer, release of materials bound to the heteropolymer, attachment of chemical species to the heteropolymer, attachment of chemical species to materials bound to the heteropolymer, crosslinking of materials interacting with the heteropolymer, crosslinking of materials within the heteropolymer element, enzymatic digestion of materials within the heteropolymer, chemical modification of materials within the heteropolymer element, introduction of calorimetric reagents, isotopic labels, and etc.

Further, the array format spatially encodes the peptides so that it is easier to probe than the split pool libraries. These arrays can be probed with multiple analytes for sensor development, drug discovery, or for cell adhesion in biomaterial development.

The disclosed methods can, in certain examples, be used to characterize materials that comprise all or a portion of the heteropolymer array or materials that interact with the heteropolymer array.

In the case of materials that comprise the heteropolymer array, polymer structures are modified using labile linking groups, including photolabile, electrically labile, and chemically labile groups. These groups can then be reacted with other chemical groups using labile protective groups including photolabile, chemically labile, or electrically labile protective groups to form heteropolymer arrays (typically DNA, RNA, peptide, protein, etc.) attached to the polymer surface. These materials can be characterized using, e.g., MALDI-MS after cleaving the linking group.

In the case of materials that interact with the polymer array, the heteropolymer array is constructed, for example, using protective groups as described above or by printing or spotting techniques. This heteropolymer-polymer structure array is then allowed to interact with materials of interest. The array is then tested using common analytical techniques to study this interaction. In one case, where the interaction is protein binding to the array, techniques such as MALDI-MS are use to identify the proteins that have bound to the array. In this case peptide mass fingerprinting can be used, where a protease digest is used to break the protein into peptides. Any portion of these peptides can be identified using MALDI-MS and compared with a database, identifying the protein based on the peptide fragments.

Heteropolymer arrays also include arrays of potential cell recognition factors or binding factors. Where direct characterization of the array after interaction with cells is used to determine which heteropolymer interact or prevent interaction with the cells.

The disclosed methods and compositions can allow the generation of small three dimensional structures that can be functionalized in spatially defined ways for the construction of sensors, catalysis, biomaterials, drug delivery, molecular evolution, etc.

The high site density of the polymer substrates on this array surface provide sufficient sample of each array element and/or materials bound to each element to obtain the mass or masses of materials directly from the array. This method for direct MALDI-TOF mass spectrometry characterization can be used to characterize numerous groups bound to the array. These groups include, but are not limited to, DNA, RNA or proteins bound to regions of interest of DNA/RNA (i.e., a promoter region).

The disclosed methods also allow for RNA/DNA hybridization of unlabeled probes. The disclosed methods do not preclude the use of fluorescent labels; hence labeled samples can be used and characterized by fluorescence and with in situ MALDI. The use of the high site density substrate significantly increases the fluorescent signal from arrays, such that arrays can be analyzed by simple inexpensive equipment in some cases even by eye. This again is a dramatic contrast to the current DNA arrays composed of monolayers that require very sensitive equipment for analysis.

This represents a significant improvement over current techniques. Proteins or molecules/complexes that bind the array can also be characterized using this technique with or without peptide mass fingerprinting. The disclosed methods can allow the characterization of peptide arrays, a necessary step towards commercial viability or peptide chips. Further, the disclosed methods can be used to assay for molecular recognition, in this case an array of possible polymers are constructed that may bind to a given materials. Screening can be accomplished in parallel; a mixture of possible materials that will bind to the array can be hybridized. Tryptic digest of protein samples and in-situ MALDI-MS can be used to determine what bound to which location. In the case of proteins, peptide mass fingerprinting can be used to determine the identity of proteins bound to the array. This allows for the rapid parallel screening for molecular recognition which may find wide spread application for medical and sensor applications.

The in situ characterization of a peptide array attached to a photopolymer array using MALDI-TOF mass spectrometry (MALDI) has been demonstrated. The polymer gel has a large number of surface sites, allowing for the spatially addressable synthesis of enough peptide for characterization via MALDI. The disclosed methods can allow the characterization of peptide and DNA microarrays, as well as arrays of other molecules that lend themselves to MALDI. The MALDI can be used to determine the molecular mass of materials comprising each element or bound to materials at each element. Post source decay can be used to determine the sequence of heteropolymers, primarily peptides comprising or bound to each element. In situ tryptic digests and peptide mass fingerprinting can be used to identify proteins comprising or bound to array elements.

Another aspect of the disclosed methods is the in situ characterization of materials bound to the array. This significantly expands the applications of arrays. For example, this has immediate application as new DNA arrays that do not require that RNA/DNA samples be labeled before hybridizing to the array. The disclosed methods can also be used to identify proteins that bind to DNA regions of interest (in this case, array elements).

### Microarrays

By “microarray” is meant any arrangement of two or more microstructures or microdomains. Microarrays that are suitable for use herein are described in PCT/US05/015764, which is incorporated by reference herein in its entirety for all of its teachings, including but not limited to its disclosure of microarrays, their preparation, characterization, and use.

Microarrays and DNA arrays in particular have become widely used tools for biomolecular research. High density arrays with as many as several hundred different DNA sequences are commercially available. The utility of these arrays is that it allows large numbers of DNA or RNA sequences to be screened in parallel. Microarrays are typically comprised of a planar substrate, such as glass, upon which heteropolymers, typically DNA or RNA are attached. Each element has known position and sequence. Hence, the array encodes the identity of each array element by its spatial position. This format is very useful in that it allow researchers to compare many sequences at once by exposing the array to a solution containing fluorescently labeled probes.

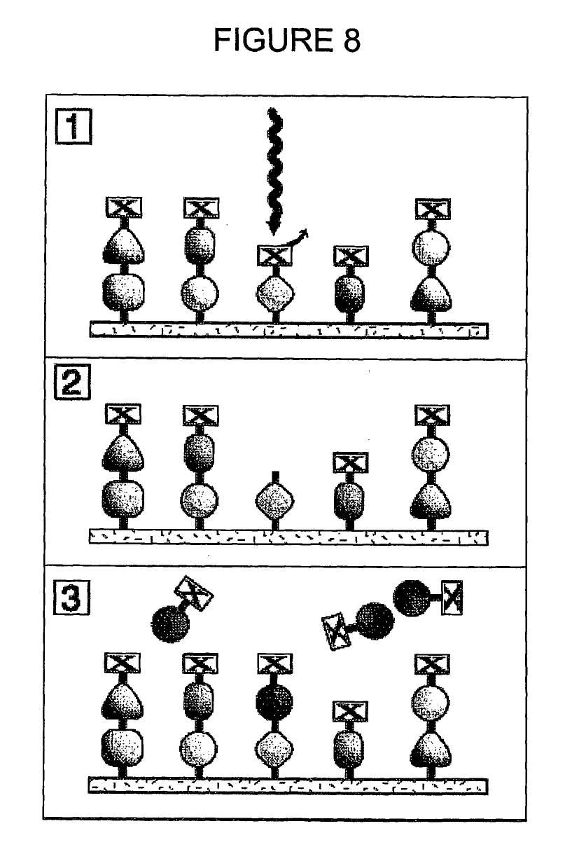

Fodor's initial work shows that high site density peptide arrays could be constructed using techniques similar to those used to make DNA arrays as illustrated in FIG. 8. Specifically, photolabile groups are removed from surface bound amino groups using a lithographic process followed by coupling of N-protected amino acids to these regions. This process is repeated until the array has been created.

To date this has not been a successful approach and SPOT-synthesis developed by Frank has been the primary in situ method for constructing peptide arrays. In this method peptides are synthesized in situ by sequentially spotting the various amino acids and coupling reagents onto the appropriate spots to construct the desired peptide array on membrane support, typically cellulose. This results in low density arrays (features ˜1 mm diameter), but with much higher site density, typically 0.1 to 1 μmol/cm².

There are several possible reasons why the light directed approach has not been successful for peptide versus DNA. One potential problem that there are twenty naturally occurring amino acids versus the four deoxyribonucleic acids, significantly increasing the number of synthesis steps to create peptide arrays. However, peptide arrays based on limited numbers of amino acids still have wide-spread application.

Another major advantage in DNA arrays over peptide arrays is the ease in characterizing DNA arrays. All that is required to probe any given element is to make a fluorescently labeled complimentary probe. Characterizing a peptide array is a tremendous challenge especially since there are only a handful of specific monoclonal antibodies for short peptides.

A more efficient means for characterizing a peptide array can be in situ detection of the constituent peptides. This is extremely difficult on a monolayer array given that less than a femtomole of material is present within an array element. Mass spectrometry is among the most sensitive analytical techniques and commercial instruments are available that allow facile data collection and interpretation. Mass spectrometry can be used to identify the ions present in the sample as well fragmentation patterns of the parent ions. This information can be used to identify a given sample including to sequence peptides.

Matrix Assisted Laser Desorption Ionization (MALDI) is a mass spectrometry ionization technique which uses a scanning laser to ablate the sample and form the ions. Because this process is spatially addressable it naturally lends itself to the characterization of arrays. MALDI-MS has detection limits in the low picomole range, though in some cases femto and attomole concentrations can be detected. Due to this extreme sensitivity in some applications MALDI-MS to characterize monolayers of peptides have been reported. However, in general higher concentrations would greatly facilitate detection.

Towards this ends we have used high site density porous polymer structures as a platform for light directed synthesis. These high site density materials provide sufficient concentrations for direct monitoring of coupling steps using colorimetric tests and in situ array characterization using MALDI-MS. Methods of fabricating arrays of porous polymer structures and synthesizing peptide arrays on these structures are also reported.

This approach can allow construction of large arrays of peptides on the polymer microstructures. Such arrays can allow potentially allow high throughput separation of proteins from complex biological samples, where proteins with strongest affinity for a given element are enriched and subsequently protein identified using MALDI-MS. Peptide arrays can also be screened for affinity for a ligand of interest and therefore used in sensor development.

### Polymers/Monomers

It is desirable for photopolymer microstructures for solid phase synthesis and in situ characterization via MALDI-MS to have properties such as high site density, rapid diffusion, high resolution photopolymerization, and mechanical robustness to withstand the various synthesis and characterization steps. For a system where it is desired to detect fluorescence from the array, it is desirable that the polymer system not absorb the excitation light and that it not emit at the detection wavelength. In this case, any nonfluorescent, nonabsorbing (at the deprotection wavelength) and nonemiting (at detection wavelength) polymer or monomer systems can be used, including monomers that are polymerized or polymers that are cross-linked or both. Suitable examples include, but are not limited to, one or more of the following: acrylate, methacrylate, urethane, epoxy, urea, cellulose monomers, protein, glycols, lactic acid, caprolactone, trimethylene carbonate, N-vinylpyrrolidinone, 2,2-dimethoxy-2-phenylacetophenone, esters, propylene, ethylene, styrene, amide, ethers (acetal), halogenated monomers, amino acids, sugars, esters, nucleic acids (including DNA and RNA), peptides, and conducting polymers such as polypyrrole, polymers of these monomers, and/or combinations of these monomers.

The polymers/monomers can themselves contain pendent reactive groups like hydroxyl, epoxy, amino, carboxylate, vinyl, acrylate, methacrylate, or they can be incorporated after the polymerization reaction, for example amination of polyethylene. Specific examples are methacrylates and acrylates.

During chemical synthesis, it is often desirable to utilize a solvent that will swell polymer gels and solvate the growing polymer chain and or reactants thereby modifying the pore structure of the polymers. Anhydrous solvents with the appropriate solvation properties are typically desirable given these considerations though water is often used for certain reactions such as attachment of DNA to reactive polymer microstructures. Common solvents include acetonitrile, N,N-Dimethylformamide (DMF), Dimethyl sulfoxide, 1-Methyl-2-pyrrolidone (NMP), and tetrahydrofuran (THF). Other suitable solvents include, but are not limited to, alcohols (e.g., methanol, ethanol, butanol, isopropanol, cyclohexanol), acetone, acetonitrile, toluene, etc.

Further, the polymers/monomers can contain pendent reactive groups like hydroxyls, epoxy, amino, etc. groups, or they can be incorporated after the polymerization reaction.

### Photoinitiators

Suitable photoinitiators (PIs) are disclosed in Fouassier, Progress in Organic Coatings, 47:16-36, 2003, which is incorporated by reference herein for its teachings of photoinitiators. Specific examples include, but are not limited to, halogens, halogenated organic compounds, hydrogen peroxide, alkyl hydroperoxides, cumene hydroperoxide, peroxides, benzoyl peroxide, non-ketonic peresters, ketones, quinones, polycyclic hydrocarbons, azocompounds, hydrazones, cyclic acetals, 1,3-dithiolane, saccharides, metal oxides, ion pair complexes, metal chlorides, uranium salts, metal carbonyls, metal acetylacetonates, ferrocene, metal complexes, dyes, and polymeric photoinitiators. Radical initiators such as azides (e.g., azobisisobutyronitrile and derivatives thereof), ketones (e.g., benzophenone, thioxanthone, acridone aromatic diketones and derivatives thereof), ketocoumarins and coumarins derivatives, dyes (e.g., xanthene dyes such as eosin (EO) or Rose Bengal (RB), thioxanthene dyes or cyanins), thioxanthones, bis-acylphosphine oxides, peresters, pyrylium and thiopyrylium salts in the presence of additives such as a perester, cationic dyes containing a borate anion, dyes/bis-imidazole derivatives/thiols, PS/chlorotriazine/additives, metallocene derivatives (such as titanocenes), dyes or ketones/metallocene derivatives/amines, cyanine dyes in the presence of additives, dyes/bis-imidazoles, miscellaneous systems such as phenoxazones, quinolinones, phthalocyanines, squaraines, squarylium containing azulenes, novel fluorone visible light PIs, benzopyranones, rhodamines, riboflavines, RB peroxybenzoate, PIs with good photosensitivity to the near IR, camphorquinone/peroxides, pyrromethane dye, crystal violet/benzofuranone derivatives, two color sensitive systems, etc.

Colored cationic P's (such as iron arene salts, novel aromatic sulfonium or iodonium salts) and PS/cationic PI (where PS can be hydrocarbons or ketones or metal complexes) can help to shift the absorption in the visible wavelength range.

Non-ionic photoacids and photobases for the generation of active species in photoresists technology are developed. By now, the design of colored species and proposals of PS for their decomposition remains attractive challenges. However these can be used to remove acid or base labile protective groups in heteropolymer synthesis as described herein.

Excited state processes of photosensitive systems for laser beams and/or conventional light sources induced polymerization reactions have been reported in recent works. Typical photosensitive systems under visible lights are classified as One-component system (such as bis-acylphosphine oxides, iron arene salts, peresters, organic borates, titanocenes, iminosulfonates, oxime esters, etc). Two-component systems work through, e.g., electron transfer/proton transfer, energy transfer, photoinduced bond cleavage via electron transfer reaction, electron transfer. In three-component systems the basic effect is enhance the photosensitivity by a judicious combination of several components.

### Photolabile or Electrically Labile Protecting Groups

Photolabile protecting agents include, but are not limited to, o-nitrobenzyl alcohol derivatives, α-ketoester derivatives, benzophenone reduction, photosolvolysis-related reactions, benzyl alcohol derivatives, benzyl alcohol derivatives, benzoin esters, phenacyl esters, acylating agents, fluorenecarboxylates, arylamines as photo-reductors, benzophenone as photooxidant, photoisomerisation trans-cis, cinnamyl esters, and substituted vinylsilanes. Other specific examples include nitroveratryloxycarbonyl, 5′-((alpha-methyl-2-nitropiperonyloxy)carbonyl) or other desyl, nitrophenyl, or coumarins. Electrically removed protective groups used in peptide synthesis include the 4,5-diphenyl-4-oxazolin-2-one group developed by Sheehan (Org. Chem. 38:3034, 1973) and the z-group developed by Zervas (Bergmann, and Zervas, Ber. Dtsch. Chem. Ges. 65:1192, 1932).

Thus, provided is a method for constructing arrays of three-dimensional heteropolymer microdomains comprised of a plurality of sites (as taught herein and in both in U.S. provisional application Ser. No. 60/569,370, filed May 6, 2004, and the U.S. patent application, which claims priority to 60/569,370 filed May 6, 2005) comprised of combinations of one or more spatially addressable steps and chemical steps. The order of this approach can be changed but in general it is comprised of alternating between chemically labile protective groups and spatially addressable protective groups. To illustrate this, a porous and or polymer gel surface including continuous or noncontinuous surfaces is initially protected with the spatially addressable photolabile protective group MeNPOC. This group is the selectively removed using a light modulation system. Once this photolabile protective group has been removed the desired microdomains, monomers protected with a chemically labile protective groups are coupled, in this case a Fmoc amino acids. Once all the desired deprotections and coupling are complete the chemically labile group is removed and either subsequent chemical steps are performed or a new spatially addressible protective group is introduced and the process is repeated. Following this approach the spatially addressible groups are used where it is desired to have diversity and sequential chemical steps common to heteropolymer steps can be used for constant regions. MeNPOC can be substituted for the Fmoc group and the process is repeated. In the method, the spatially addressable step can involve the release of a photolabile protective group and the chemical steps are chemical coupling of protected monomers and chemical release of acid or base labile protective groups. The microdomains can contain high concentrations of nucleophilic and or free radical scavengers. This addresses the problem of colored product. For example, the scavenger can contain one or more thiol group.

### Coupling Agents, Orthogonal Protective Groups, and Chemically Labile Linkers

Coupling agents, orthogonal protective groups, and chemically labile linkers are common to the art and are described in the NOVABIOCHEM catalog 2004 or books like Williams, “Chemical approaches to the synthesis of peptides and proteins,” Albericio and Giralt. CRC Press, Boca Raton, Fla., 1997. Specific examples for DNA include the use of phosphoamidites and dimethoxytrityl protective groups. For peptides, the use of coupling agents such as carbodiimides such as DCC, DIC, etc, phosphonium or uranium agents such as BOP, HBTU, HATU, HCTU, pre-formed active esters, pre-formed anhydrides, amino acid halides, and the like are suitable. Further examples of protective groups include, but are not limited to, acid labile, reductively labile, thermally labile, electrochemically labile, and photolabile protective groups. Common groups include acid labile 4,4′-Dimethoxytrityl (DMT) or other tryityl derivatives, tert-butyoxycarbonyl (BOC) and tert-butyl (t-but) groups, base lable groups such 9-fluorenylmethoxycarbonyl (FMOC), reductively labile groups such as the benzyloxycarbonyl group (cbz), and photolabile protecting agents such as aromatic nitro compounds such as nitroveratryloxycarbonyl (NVOC), 5′-((alpha-methyl-2-nitropiperonyloxy)carbonyl, (alpha-methyl-o-nitropiperonyl)oxy]carbonyl (MeNPoc), 2-(2-nitrophenyl)ethoxycabonyl, 2-(2-nitrophenyl)ethylsulfonyl, and nitrophenylpropyloxycarbonyl. Other groups include 1-pyrenylmethyloxycarbonyl, alpha-ketoester derivatives, benzyl alcohol derivatives, benzoin derivatives, phenacyl esters, coumarin derivatives, hydroxyphenacyl, and benzyloxycarbonyl.

Examples of labile linkers include, but are not limited to, acid labile linkers such the RINK amide linker, oxidativly labile hydrazinobenzoyl linker, base labile and or linkers cleaved by nucleophiles such as 4-hydroxymethyl benzoic acid linkers, or photolabile linkers such as the hydroxyethyl photolinker. These can be used to selectively remove materials from the polymer surface.

### Groups to be Added

Any group that allows construction of polymers or combinations of polymers described previously can be used. Groups to be added onto the polymer include, but are not limited to, sugars, amino acids, nucleic acids, multifunctional amines, ethylene glycol, acid labile groups, base labile groups, dyes, redox species, porphyrins, and combinations of or polymers of these monomers. Sequential light directed synthesis can be used to build complex sequence specific polymers.

### Method of Light Modulation

Light can be modulated using a scanning laser system composed of a laser, shutter, microscope objective, and stage. In this case, the stage movement and shutter are controlled so that the shutter is only open when the stage is positioned so that the light will illuminate a desired position.

Photolithography is well known to the art, but briefly it utilizes masks where light is blocked by some parts of the mask and not others. In this way the illumination reaching the sample can be controlled. Light sources typically include lamps or lasers.

Micromirror arrays are a more recent way of modulating light. By changing the angle of the mirrors in the array, light can be directed towards a surface or not. In this way light from an excitation source (lamp or laser) can be selectively reflected onto desired regions of the sample to be exposed.

Liquid crystal arrays or display systems can also be used to modulate light in a patterned fashion by changing the polarization, reflective properties or absorbance properties of the light (transmitted or reflected).

In the disclosed methods a micromirror array, liquid crystal array or scanning laser system are suitable methods for modulating light.

### Methods of Direct or Indirect Electrochemical Patterning

Arrays of electrodes can be used to pattern electrochemical reactions including electrochemical formation of acids, bases, reduced species, oxidized species or reactive species. Alternatively, direct electrochemical removal of protective groups in a patterned way can be done in this fashion.

### Substrate

Substrates include, but are not limited to, glass, quartz, silicon, silicon oxide or other metal, and metal oxide surfaces, or polymers bearing reactive groups. It is not necessary that they be transparent since illumination can be from above. In the case of glass, quartz, and silicon oxide, these surfaces can be modified to react with the polymer for a covalent linkage; although, this may not be desirable or necessary in all cases since intermolecular attractive forces can be used to “glue” the features to the substrate. Where modification is desirable, silanes common to the art can be used, the most common being aminopropyl triethoxysilane or 3-(trimethoxysilyl)propyl methacrylate.

The silanization of the glass substrate can be performed as follows. Glass cover slides are cleaned. The slides are immersed for 15 minutes at room temperature with 60/40 (v/v) sulfuric acid/hydrogen peroxide, 10% sodium hydroxide (w/v) at 70° C. for 3 minutes and 1% HCl at RT for 1 minute. Between steps, the slides are soaked in nanopure water for 3 minutes. A solution of 1-5% 3-(trimethoxysilyl)propyl methacrylate or aminopropyltriethoxysilane (APTES) in 95% ethanol/5% water is prepared and mixed for 10 minutes. The slides are immersed in the silane solution at room temperature for 15 minutes with gentile agitation. Slides are soaked in isopropyl alcohol for 3 minutes, nanopure water for 1 minute, and placed in a 100° C. oven for 5 minutes after which the oven is turned off and nitrogen is blown through for 1 hour. The slides are stored under nitrogen or argon.

### System for Introducing Reagents

Systems for introducing and removing reagents include, but are not limited to; a flow cell, spotters, or printers, stampers, microfluidic devices, etc. coupled with manual or automated introduction and removal of reagents. Wells or plates where reagents are introduced manually or automation. Automation is provided by machines such as peptide synthesizers, autosamplers, and the like, that are designed to introduce and remove reagents.

Serial Assembly of Molecule

The substrate is an electrode upon which has been eletropolymerized a layer of an amine-modified indole. The porphyrin is attached to the indole polymer at two positions via peptide bonds. The porphyrin (a modified tetraphenylporphyrin) has four attachment sites, in this case amine groups, originally synthesized with orthogonal blocking groups. These blocking groups are then released (one or more at a time) and peptide synthesis is performed at that site. Thus one is sequentially attaching amino acids to four different positions on the same molecular assembly. This is a heteropolymer of sorts in that it consists of a small set of monomers (porphyrins and amino acid groups), but it is branched and requires the careful sequential use of multiple orthogonal protective groups that are sequentially released exposing new sites for continued patterned synthesis using either optically or electrochemically patterned synthesis methods. It is also an example of a catalyst (the porphyrin is the active site and the peptides generate a catalytic pocket). It is also an example of using polyindole (a conductive polymer) as a substrate to do in situ chemistry on. It is also an example of performing patterned synthesis directly on electrodes, creating a chemical/electronic hybrid system (in this case the idea is to reduce carbon dioxide using an electrical potential supplied by the electrode).

### Analytical Techniques

Array elements can be probed in situ through various spectroscopic techniques including fluorescence, SIMS, FAB, FTIR, CD, Raman, Surface Plasmon Resonance, absorbance measurements, mass spectrometry, enzymatic reactions, calorimetric stains, or elements can be removed from the surface and through the use of labile linkages between the coupled material and the polymer. Thus, the material can be cleaved and a host of analytical techniques can be used including HPLC, NMR, mass spectrometry, including MALDI and DESI capillary electrophoresis, and the like. Other suitable examples include detection of hybridized, bound, or covalently linked probes or groups using fluorescence, FTIR, and mass spectrometry. Therefore, these arrays are amenable to multidimensional analysis.

The preceding technological disclosure describes illustrative embodiments of this invention and does not limit the present invention and method to those precise embodiments. Further, any changes and/or modifications, which may be obvious by one with ordinary skill in the related art, are intended to be included within the scope of the invention.

### Methods of Use

This invention can be used to determine materials comprising the microarray or materials interacting with the microarray, including but not limited to, heteropolymers including proteins, DNA, RNA, sugars, lipids, etc., small molecules, cells, tissues, etc. In the case of direct characterization of the heteropolymers attached to the porous polymer and or polymer gel, this material is typically released from the surface (e.g., by trypsinization) prior to analysis by mass spectrometry. For example a peptide microarray is characterized by cleaving a labile linker and the peptide is characterized using mass spectrometry. This can reveal modifications of the heteropolymer itself or materials interacting with the microdomain have been modified through some interaction with an analyte or multiple analytes for example modification by a kinase and this phosphorylation detected using peptide mass fingerprinting and MALDI-MS.

Using this technology an array of molecular recognition factors for proteins of interest is constructed. For example an array of ˜35 k recognition elements for all known human proteins. This is used to study human cells under various conditions including disease or treatment with drugs, and etc. This array reveals which proteins are present and if and how they have been modified.

This invention can also be used to determine the identity or otherwise characterize materials that interact with heteropolymers attached to the polymer microarray. For example a DNA microarray is constructed and peptide mass fingerprinting and MALDI-MS is used to identify proteins bound to the DNA. Here arrays comprised of portions of genes of interest (double stranded DNA are constructed, through spotting, hybridization, in situ primer extension, and etc) where each microstructure contains a portion of the gene. This is treated with cell, tissue, fluid, and etc extracts to identify new transcription factors, to study the influence of conditions on transcription factor binding and etc and the array is assayed using MALDI-MS or other techniques to characterize materials bound to the array.

In another example one or more aptamers known to bind given proteins are attached to the microstructures. This is then exposed to a biological sample and MALDI-MS is used to characterize the biomolecule or metabolite, including, determining if the biomolecule or metabolite has been modified in some way. In a further example, a peptide or protein microarray on polymer microstructures is constructed, exposed to a biological sample and MALDI-MS is used to identify biomolecules or metabolites that have bound to the microarray. In another example, a DNA or RNA array is constructed on the polymer microstructures and DNA or RNA is hybridized and detected using MALDI-MS without the need for fluorescent probes. In a further example, a peptide or protein array is constructed and screened for cell adhesion and or changes in cell function. Here cells can be detected by staining and changes in function can be detected using optical or MALDI-MS.

One skilled in the art will recognize the numerous polymer/monomer formulations, thus the preceding technological disclosure describes illustrative embodiments of the disclosed subject matter and does not limit the present invention and method to those precise embodiments. Further, any changes and/or modifications, which may be obvious by one with ordinary skill in the related art, are intended to be included within the scope of the invention.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

Materials

3-(trimethoxysilyl)propyl methacrylate was from Fluka GmbH (Buchs, Switzerland). Calmix2 and N,N-dimethylformamide (DMF) was from Applied Biosystems Inc. (Foster City, Calif.). Cyclohexanol, azo-bis-isobutyronitrile (AIBN), β-mercaptoethanol, piperidine, semicarbazide hydrochloride, TMPP-acetic acid, N-hydroxysuccinimide ester (TMPP-Ac—OSu-Br), dichloromethane (DCM), α-cyano-4 hydroxycinnamic acid, and diisopropylethylamine (DIPEA) were from Sigma-Aldrich Chemical Co. (Milwaukee, Wis.). Glass coverslips were from Bioptechs (Butler, Pa.). ((α-methyl-2-nitropiperonyl)oxy)carbonyl chloride (MeNPOC—Cl) was from Cambridge Major Laboratories Inc. (Germantown, Wis.). Isopropanol and ethanol (95%) were from ACROS Organics (Geel, Belgium). Acetonitrile and bromophenol blue were from Alfa Aesar (Ward Hill, Mass.). Methanol, sulfuric acid, and hydrochloric acid were purchased from Mallinckrodt Inc. (Paris, Ky.). Fmoc-Glycine (Fmoc-G), Fmoc-Phenylalanine (Fmoc-F), Fmoc-Leucine (Fmoc-L), Fmoc-tyrosine-tbut (Fmoc-Ytbut), and Trifluoracetic acid (TFA) were from Advanced ChemTech Inc. (Louisville, Ky.). Fmoc-Rink amide linker and Fmoc-Aminohexanoic acid (Fmoc-Ahx) were from NovaBiochem, a division of EMD Biosciences, Inc. (San Diego, Calif.). O-(7-Azabenzotriazol-1-yl)-N,N,N′,N′-tetramethyluroniumhexafluorophosphate (HATU) was purchased from Anaspec Inc. (San Jose, Calif.). Water was purified using a NANOPure ultrapure filtration system from Barnstead. (Dubuque, Iowa). 3′-nitrophenylpropylcarbonyl (NPPOC) was from NimbleGen Systems GmbH (Waldkraiburg, Germany).

Equipment

The flow chamber used was a FCSII from Bioptechs Inc. (Butler, Pa.) and was used for all reactions. Patterning was performed using a SF—IOU micromirror array from Intelligent Micro Patterning, LLC, (St. Petersburg, Fla.). Peptide synthesis was done using a Milligen 9050 peptide synthesizer, Millipore Co. (Bedford, Mass.). Mass spectrometry performed on a Voyager-DE SIR MALDI-TOF mass spectrophotometer, Applied Biosystems Inc. (Foster City, Calif.). The 380/50 (center wavelength/band width) excitation filter was from Chroma Technologies Corp. (Rockingham, Vt.). Spectrophotometry was performed us a Cary 50 UV-Vis spectrophotometer, Varian Inc. (Palo Alto, Calif.). Scanning electron microscopy (SEM) was performed using a XL3OESEM environmental SEM, FEI Co. (Hillsboro, Oreg.) on a sample coated with 3.5 nm palladium/gold or 8 nm gold with accelerating volatages of 3-20 KV. Images taken with a FUJIFILM S51000 digital camera (Tokyo, Japan) using a 50 mm Nikon AF NIKKOR macrolens (Tokyo, Japan).

### Example 1

### Light Directed Synthesis and In Situ MALDI-MS on Polymer Microstructure Encorporating Solid Phase Synthesis Resin

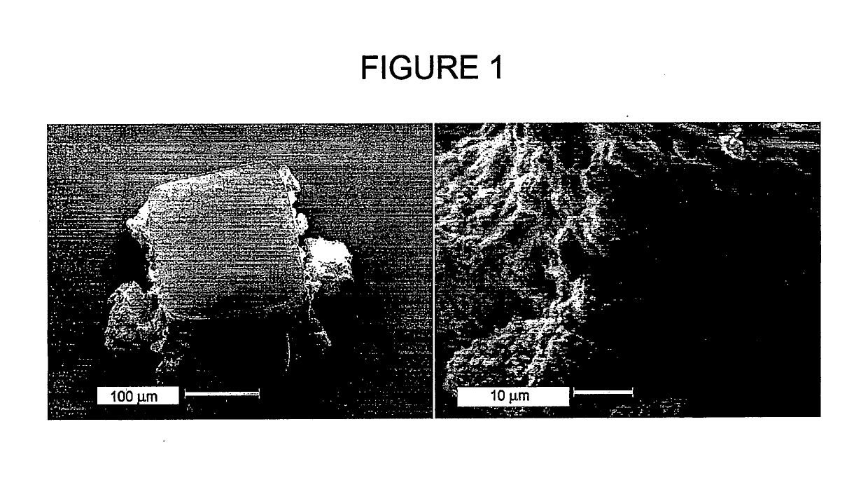

Coverslips were prepared as described above. Solid phase synthesis resin was prepared and ground: 0.3 g 2-aminoethyl methacrylate, 1.95 g poly(ethylene glycol)dimethacrylate, 1.39 g trimethylolpropane ethoxylate (14/3 EO/OH) triacrylate, 50 mg azo-bis-isobutyronitrile, and 8 mL cyclohexanol. Nitrogen was bubbled through this solution for 10 minutes to remove oxygen and then the solution was heated to approximately 90° C. for approximately 20 minutes. After polymerization, the polymer was ground in a mortar and pestle, washed with a pH 2 TFA water solution, water, and then methanol, dried, and dry sieved with a 75 micron sieve. In this case, 20 mg of this resin is swollen in 40 microliters (μL) methanol and suspended in 340 μL of a solution of 1% 2,2′-azobisisobutyronitrile (AIBN) and trimethylolpropane trimethacrylate (TRIM). Nitrogen is bubbled through the solution for 10 minutes to remove oxygen before loading it into a nitrogen purged flow cell with a methacrylate functionalized glass slide and a 250 μm thick gasket separating the coverslip from the upper glass slide. The resin is polymerized using a micromirror array with a 380/50 nm bandpass filter for 5 minutes at an intensity of 54 mW/cm² and rinsed with methanol and DMF to remove unpolymerized monomer. CLEAR II resin was selected due to its desirable solvent swelling properties, high site density, and the possibility that pendant acrylate and methacrylate groups can polymerize with the photopolymer solution. The resin was prepared, ground, and sieved to obtain small particles which were suspending in the TRIM/AIBN solution. This mixture was deoxygenated and placed in an optical cell containing a glass coverslip silanized with 3-(trimethoxysilyl)propyl methacrylate. Illumination using a micromirror array resulted in rigid highly cross-linked polymer microstructures coated with SPS resin. These microstructures are roughly cubic with 250 μm sides (FIG. 1).

An array of these microstructures was constructed using the photolabile group NVOC where half of the features had the TMPP group and the others had the NVOC group. In situ MALDI-MS was used to confirm the light directed modification of the polymer microstructures.

The Rink amide linker was coupled to the microstructures by reacting 63 μmoles of Fmoc-Rink, 22.5 mg (59 μmoles, 0.94 eq) HBTU and 11.5 μL (66 μmoles, 1.5 eq) DIPEA in 600 μL DMF for 3 minutes, then adding to the microstructures and reacting at 50° C. for 30 min. The surface was rinsed with DMF until the absorbance at 300 nm<0.1, and washed for 10 minutes with 20% piperidine in DMF, then again washed with DMF.

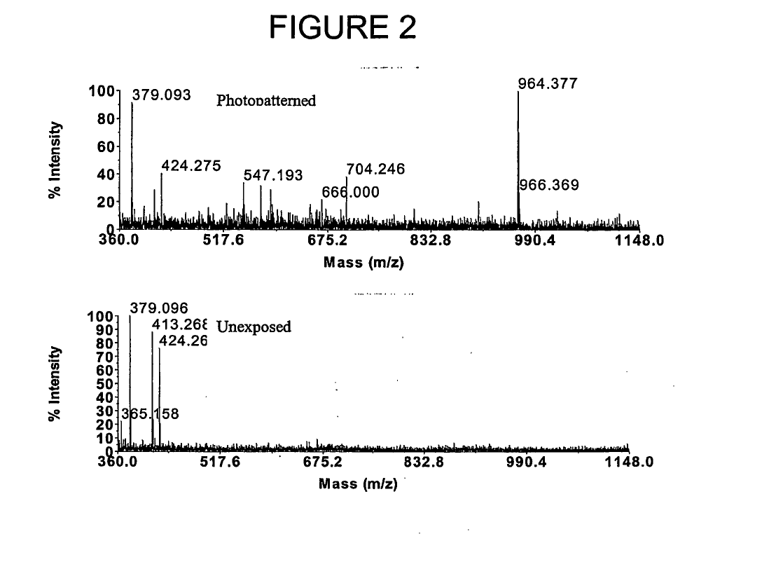

The microstructures were found to have on roughly 1 mmole/feature of reactive sites as determined by the dibenzofulvene-piperidine adduct absorption at 301 nm. Fmoc-GGFL-COOH was coupled using the same procedure except 12 mg Fmoc-GGFL-COOH, 5.4 mg HBTU, and 13 μL DIPEA was allowed to react for 1 hr. The photolabile protective group NVOC was added by reacting a solution of 19 mg NVOC in 40 μL DIPEA and 600 μl DMF with the aminated polymer microstructures for 30 min at 50° C. Photodeprotection was done in a 1% solution of semicarbazide HCl in methanol with 5 minutes of illumination from the micromirror array. TMPP-Ac—OSu-Br was coupled by dissolving 1 mg, 20 μL DIPEA in 480 μl DMF and reacting it for 1 hour at 35° C. Polymer microstructures were individually spotted with ˜1 μl of (1:1:1) solution of TFA, acetonitrile, and nanopure water for >30 minutes and then allowed to dry. These are individually spotted with ˜1 μl of a saturated solution of alpha-cyano-4-hydroxycinnamic acid dissolved in 50% acetonitrile, 0.1% TFA, and nanopure water. Samples are dried and loaded into the MALDI-MS with a custom sample holder. Here the product (TMPP-GGFL-amide) is found to be the very prevalent ion 964.377 Da (964.410 Da predicted) seen in the photopatterned microstructures and not in the control microstructures (FIG. 2).

This demonstrates the in situ synthesis and characterization of a heteropolymer array on polymer microstructures where comprised of a material with high density of reactive sites and a photopolymer which provides mechanical stability.

### Example 2

### Direct Formation of Polymer Microstructures Containing Reactive Sites

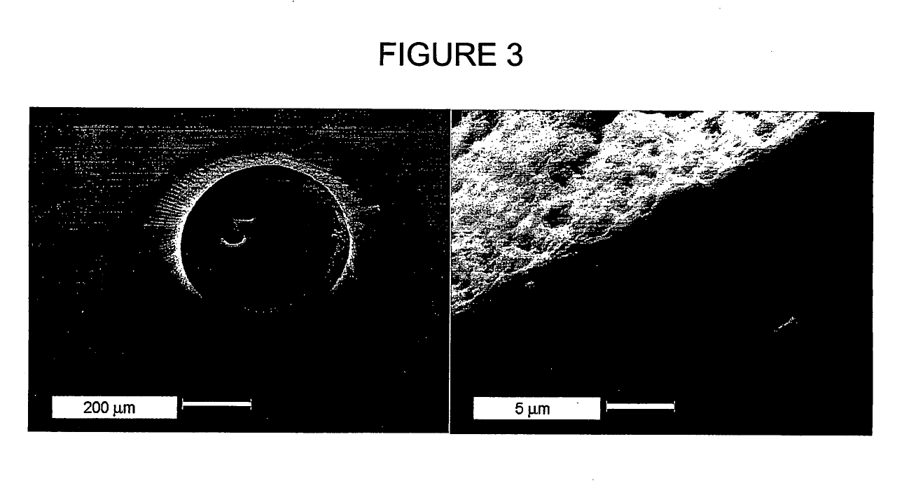

Glass cover slips were prepared as described above. Microstructures were made by the direct photopolymerization of a solution of 60 mg 2-amino ethyl methacrylate, 560 mg trimethylolpropane ethoxylate (14/3 EO/OH) triacrylate, 9.7 mg azo-bis-isobutyronitrile, 1188 mg cyclohexanol, as described in example 1 with an exposure time of 13 minutes. The slides are later washed in methanol. This resulted in 250 μm tall and 500 μm diameter porous microstructures with their corresponding numbers on the upper surface (FIG. 3). Here, the surface of the microstructures has a slightly checkered pattern resulting from the small gap between the micromirrors. It can also be noted that the base of the microstructure has a much larger diameter then the top, for the most part this is a result of the shrinkage of the microstructure in are, where the dimensions on the glass are constrained. In air these microstructures are clear, however, they turn white in DMF, reflecting the expansion of pores when the polymer swells.

These structures were then reacted with the Rink linker as described in example 1. The microstructures had ˜50 nmole/feature as determined by the dibenzofulvene-piperidine adduct absorption at 301 nm. These were reacted with Fmoc-GGFL and the Fmoc group was removed as described in example 1. In situ MALDI-MS on Polymer Microstructure Arrays was done as described in example 1.

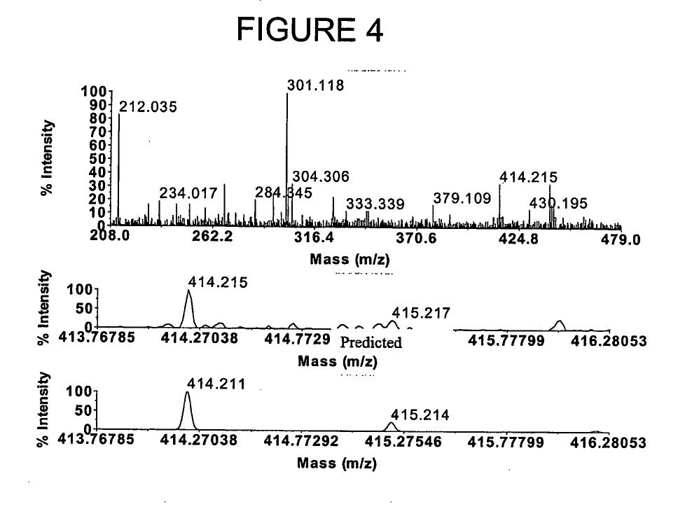

The peptide GGFL-amide was detected from the SPS microstructures as a sodium adduct (FIG. 4) since it does not have protonatable residues. The ion obtained has the correct mass (414.215 Da vs. predicted mass 414.211) and isotopic distribution. In general one disadvantage of MALDI-MS is the large number of different matrix ions which can make detection of weakly ionized small molecules difficult as is seen in FIG. 3, here the 301.118 Da may be a TFA matrix adduct, the 212.035 a matrix sodium adduct, 397.109 a matrix dimmer and etc.

### Example 3

### In Situ MALDI-MS Sequencing on Polymer Microstructure Arrays

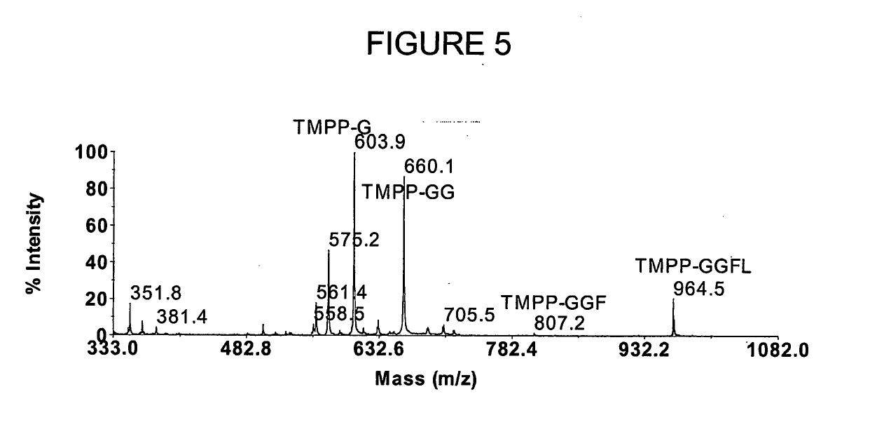

GGFL derivatized microstructures were prepared as described in example 2 and reacted with TMPP-Ac—OSu-Br as described in example 1 and in situ MALDI-MS was performed as described in example 1. The TMPP-GGFL-amide ion was analyzed using post source decay. The TMPP group facilitates the formation of secondary ions which was used to sequence the peptide. The same primary ion is observed in the post source decay spectrum, however there are several additional ‘a’ ions, corresponding to ions formed from the fragmentation of the amide nitrogen carbon linkage followed by loss of CO (FIG. 5). Inspection reveals that these ‘a’ ions correspond to TMPP-GGF, TMPP-GG, and TMPP-G and the difference in their masses is corresponds to the mass of the missing amino acids. This demonstrates the sequencing of a heteropolymer microarray in situ using MALDI-MS.

### Example 4

### Synthesis of Polymer Microstructure Array Containing Double Stranded DNA Promoter Regions and In Situ Identification of Protein Bound to DNA Through Molecular Recognition Using Peptide Mass Finger-Printing and MALDI-MS

Photopolymer gel structures were prepared as described in example 2 one spot is tested with a 1% solution of 2,4,6-trinitorbenzenesulfonic acid (TNBS) in DMF which turned bright orange indicating the presence of primary amines. This demonstrates the use of a colorimetric test for in situ characterization of a microarray. Two slides were rinsed with acetonitrile and reacted with a solution of 102.5 mg N,N′-Disuccinimidyl carbonate, 66.1 μL of diisopropylethylamine in 8 mL of anhydrous acetonitrile for 4 hrs at RT. These were then washed with DMF, DCM, and the placed in a hybridization chamber. 10 μL of 556 μM of the oligo 5′-AMINO-PEG9-CGC TTG ATG AGT CAG CCG GAA CGC TTG ATG AGT CAG CCG GAA CGC TTG ATG AGT CAG CCG GAA GCT TCC GGT AAA TTT bearing three repeats of the AP1 binding sequence were mixed with 111 μL of 30 mM tris-HCl buffer 100 mM in NaCl pH˜8 was spotted onto three of the features, the other features were spotted with a 150 μM solution of bisaminopropoxybutane in water and allowed to react overnight at 37° C. The DNA spots were then spotted with the 150 μM bisaminopropoxybutane solution and allowed to react for ˜1 hr. These were then washed with the same tris-HCl buffer and 4 μL of 3 μM 5′-Texas Red-AAA TTT ACC GGA AGC TTC CGG CTG ACT CAT CAA GCG TTC CGG CTG ACT CAT CAA GCG TTC CGG CTG ACT CAT CAA GCG and allowed to hybridize for 1.5 hrs at RT. This was again washed with the same tris-HCl buffer and imaged for fluorescence and TE buffer (100 mM Tris HCl pH 7.6, 1 mM EDTA) and left at 4° C. for 48 hrs. Only the spots with the covalently bound oligo were fluorescent.

Images of the five spot array (Figure) reveal three spots with covalently bound DNA with AP1 recognition site (top left, and right side), one spot with an orange colorimetric stain (bottom left), and a control spot without any treatment. All spots were treated with the complimentary AP1 DNA labeled with Texas Red-X dye. Green excitation light is from a overhead lamp filtered through a D560/40 filter, emission was detected with a Nikon CoolPix775 digital camera with a D630/60M filter in front of the lens. This demonstrates characterization of a photopolymer microarray using fluorescence spectroscopy.

This array was then washed with sterile water and a 1:1 mixture of rhAP1 protein 0.3 μg/ml and buffer Z (25 mM HEPES K+ pH 7.8, 12.5 mM MgCl₂, 1 μM DTT, 20% glycerol, 0.1 Nonidet p40) and 2 μL was spotted onto all 5 microstructures. This was allowed to bind for 0.5 hrs at RT and 2 hrs at 4 C and then rinsed with sterile water at 4° C. The fluorescence was rechecked and the treatment spots were still fluorescent. 2 μL of a 1:100 dilution of 10 μg/mL trypsin in 25 mM ammonium carbonate and sterile water was spotted onto one feature and the array was left at 37° C. overnight.

A slightly subsaturated solution of α-cyano-4-hydroxycinnamic acid solution of 1:2 acetonitrile:water with 1% TFA was spotted, 2 μL per feature on to the array and left in hybridization chamber for 45 min. This was then dried and spotted with 1 μL of a saturated solution of α-cyano-4-hydroxycinnamic acid in 1:1 acetonitile:water with 0.1% TFA. This was loaded into the Applied Biosystems Voyager-DE using a custom holder and the mass spectra were collected. Ions were only detected coming from the trypsin digest array element.

Peaks with areas greater then 100 were selected and entered into the program PROTEIN PROSPECTOR (UCSF):

| Centroid Mass | Relative Intensity | Area |
|---|---|---|
| 1697.778 | 100 | 7181.99 |
| 2077.124 | 26.24 | 1884.38 |
| 3476.733 | 10.46 | 751.05 |
| 1505.739 | 8.88 | 637.92 |
| 2031.98 | 5.45 | 391.6 |
| 817.4681 | 5.23 | 375.3 |
| 914.4895 | 3.76 | 269.9 |
| 2497.337 | 3.73 | 268.04 |
| 949.5104 | 3.44 | 246.87 |
| 845.5007 | 3.09 | 221.87 |
| 814.1445 | 3.08 | 220.96 |
| 877.0493 | 3.02 | 217.25 |
| 2094.13 | 2.91 | 208.74 |
| 1679.773 | 2.73 | 195.79 |
| 3494.551 | 2.73 | 195.76 |
| 889.5275 | 2.6 | 186.83 |
| 2923.321 | 2.48 | 178.37 |
| 2076.047 | 2.42 | 173.89 |
| 3355.565 | 2.34 | 168.13 |
| 861.4817 | 2.3 | 164.87 |
| 1736.816 | 2.25 | 161.88 |
| 1103.621 | 2.23 | 160.19 |
| 841.0656 | 2.21 | 158.46 |
| 1521.769 | 2.18 | 156.43 |
| 1681.562 | 2.13 | 152.7 |
| 933.556 | 2.09 | 149.83 |
| 815.1593 | 2.06 | 147.73 |
| 2092.081 | 2.06 | 147.68 |
| 2148.118 | 1.97 | 141.32 |
| 1460.781 | 1.84 | 132.38 |
| 3492.687 | 1.83 | 131.36 |
| 2958.74 | 1.66 | 119.05 |
| 3434.513 | 1.59 | 114.26 |
| 3474.65 | 1.59 | 113.85 |
| 2390.361 | 1.54 | 110.27 |
| 3435.98 | 1.53 | 109.87 |
| 3478.618 | 1.52 | 109.31 |
| 3387.657 | 1.46 | 105.02 |
| 3410.752 | 1.45 | 104.49 |
| 2446.184 | 1.43 | 103.04 |
| 3917.162 | 1.39 | 100.02 |

This program compared these peptides with the SwissProtein database and identified that they matched the fragments predicted for hrAP1 digested with trypsin with a MOWSE score of 1.18e+007:

MS-Fit Search Results

The following parameters were used in the search.

Database searched: SwissProt.r36
Molecular weight search (1000-100000 Da) selects 69977 entries.
Full pI range: 74019 entries.
Species search (HOMO SAPIENS) selects 4980 entries.
Combined molecular weight, pI and species searches select 4460 entries.
MS-Fit search selects 190 entries (results displayed for top 5 matches).
Min. # Peptides to Match: 4
Peptide Mass Tolerance (+/−): 300.000 ppm
Peptide Masses are monoisotopic
Digest Used Trypsin
Max. # Missed Cleavages 1
Cysteines Modified by unmodified
Peptide N terminus Hydrogen (H)
Peptide C terminus Free Acid (OH)
Input # Peptide Masses: 41

### Result Summary

| | MOWSE | # (%) Masses | Protein MW | | SwissProt.r36 | |
|---|---|---|---|---|---|---|
| Rank | Score | Matched | (Da)/pI | Species | Accession # | Protein Name |
| 1 | 1.18e+007 | 10/41 (24%) | 35675.8/8.90 | HUMAN | P05412 | transcription |
| | | | | | | factor ap-1 |
| | | | | | | (proto-oncogene |
| | | | | | | c-jun) (p39) |
| | | | | | | (g0s7). |
| 2 | 8.8e+003 | 5/41 (12%) | 38915.1/9.59 | HUMAN | P48729 | |

Detailed Results

1. 10/41 matches (24%). 35675.8 Da, pI=8.90. Acc. # P05412. HUMAN. TRANSCRIPTION FACTOR AP-1 (PROTO-ONCOGENE C-JUN) (P39) (GOS7).

| | | | | | | | |
|---|---|---|---|---|---|---|---|
| m/z | MH+ | Delta | | | | SEQ | |
| submitted | matched | ppm | start | end | Peptide Sequence | ID | Modifications |

| | | | | | | | |
|---|---|---|---|---|---|---|---|
| 914.4895 | 914.4947 | −5.7127 | 71 | 78 | (K)LASPELER(L) | 1 | |
| 1505.7393 | 1505.7382 | 0.7067 | 289 | 302 | (K)AQNSELASTAN | 2 | |
| | | | | | MLR(E) | | |
| 1521.7691 | 1521.7331 | 23.6148 | 289 | 302 | (K)AQNSELASTAN | 3 | 1Met-ox |
| | | | | | MLR(E) | | |
| 1697.7784 | 1697.7771 | 0.7699 | 102 | 116 | (K)NVTDEQEGFAEG | 4 | |
| | | | | | FVR(A) | | |
| 2076.0471 | 2076.0912 | −21.2311 | 36 | 54 | (K)QSMTLNLADPV | 5 | pyroGlu |
| | | | | | GSLKPHLR(A) | | 1Met-ox |
| 2077.1235 | 2077.1228 | 0.3384 | 36 | 54 | (K)QSMTLNLADPV | 6 | |
| | | | | | GSLKPHLR(A) | | |
| 2497.3374 | 2497.3125 | 9.9769 | 79 | 101 | (R)LIIQSSNGHITT | 7 | |
| | | | | | TPTPTQFLCPK(N) | | |
| 2923.3210 | 2923.3341 | −4.4791 | 227 | 252 | (K)EIEPQTVPEMPG | 8 | |
| | | | | | ETPPLSPLDMESQER | | |
| | | | | | (I) | | |
| 3476.7328 | 3476.6929 | 11.4628 | 222 | 252 | (R)LQALKEEPQTVP | 9 | |
| | | | | | EMFGETPPLSPIDME | | |
| | | | | | SQER(I) | | |
| 3492.6867 | 3492.6878 | −0.3333 | 222 | 252 | (R)LQALKEEPQTVP | 10 | 1Met-ox |
| | | | | | EMPGETPPLSPLDME | | |
| | | | | | SQER(I) | | |

31 unmatched masses: 814.1445 815.1593 817.4681 841.0656 845.5007 861.4817 877.0493 889.5275 933.5560 949.5104 1103.6213 1460.7814 1679.7727 1681.5616 1736.8158 2031.9798 2092.0813 2094.1301 2148.1181 2390.3613 2446.1842 2958.7402 3355.5649 3387.6574 3410.7523 3434.5132 3435.9801 3474.6500 3478.6177 3494.5509 3917.1623

This demonstrates the identification of a material that has interacted with the polymer microstructure array where the material is a protein and the tool for detection is peptide mass fingerprinting using MALDI-MS. This also demonstrates using spotting to generate the heteropolymer array and the use of fluorescence detection and colorimetry to analyze properties of the heteropolymer array.

### Example 5

### Glass Surface Functionalization

Glass cover slides were cleaned using a modification of literature methods (Cras et al., Biosens. Bioelectron. 14:683-688, 1999; Halliwell et al., Anal. Chem. 73:2476-2483, 2001). Slides were soaked for 30 min at RT with 1/1 (WV) hydrochloric acid/methanol, then in concentrated sulfuric acid at RT for 30 min and finally in boiling water between 10 and 30 minutes. Between steps, the slides were immersed in nanopure water at RT for 2 minutes. A solution of 5% 3 (trimethoxysilyl)propyl methacrylate in 95% methanol/5% water was prepared and stirred for 1 minute, then the slides were immersed in the silane solution at RT and allowed to react for 1 hour with gentile agitation. Slides were immersed in methanol for 3 minutes and then placed in a 100-150° C. oven. Nitrogen was blown though the oven for ten minutes and the slides were allowed to bake for 12-16 hours.

### Example 6

### Fabrication of Polymer Structures

Microstructures were made by the direct photopolymerization of a 40% monomer solution comprised of 1:3 EDMA:HEMA dissolved in 60% (m/m) porogenic solvent solution comprised of 30% (m/m) dodecanol in cyclohexanol with 1% (m/m) AIBN photoinitiator. Argon was bubbled through the solution for 10 minutes to remove oxygen before loading it into an argon purged flow cell with a methacrylate functionalized glass slide and a 100 μm thick gasket separating the coverslip from the upper glass slide. The resin was polymerized using a micromirror array with a 380/50 nm bandpass filter at an intensity of 54 mW/cm². Depending on the size of the microstructures, the solution was exposed for 5-15 minutes (larger structures require less exposure). The slide was removed from the chamber and soaked in methanol. In the case of thin films, the bulk of the material was removed with a high pressure jet of nitrogen.

### Example 8

### Synthesis on Polymer Microstructures

In General, amination of the microstructures was accomplished using 0.075 mmoles Fmoc-amino acid, 27 mg (0.071 mmoles) HATU or HBTU, 25 μL (0.15 mmoles) DIPEA, and 475 μL DMF. These were combined and allowed to react for 3 minutes before adding to the aminated surface. The reaction was allowed to go for 1 hr at 50° C. The same procedure was used in subsequent Fmoc-amino acid coupling with the exception that these were limited to 30 minutes. The Fmoc group was removed by filling the chamber with 500 μL of a 20% piperidine in DMF for 10 minutes. The photolabile protective group MeNPOC was added by reacting 33 mg (0.071 mmoles) MeNPOC—Cl, 25 μL (0.15 mmoles) DIPEA, and 475 μL DMF for >30 minutes at RT.

In constructing the peptide array microstructures were aminated with 26.5 mg Fmoc-Ahx. For each subsequent amino acid coupling a Fmoc-amino acid was coupled and the MeNPOC group substituted for the Fmoc group in situ by removing the Fmoc from the microstructures and reacting the MeNPOC—Cl with the surface. Following this, the sample was soaked in a photolysis solution comprised of 30% β-mercaptoethanol and 7% DIPEA in DMF for 5 minutes and then the desired areas were irradiated for 15 minutes using the micromirror array and filter. Between each step the chamber was rinsed 3× with DMF and 1×DCM, blowing out with nitrogen between steps. The sample stained with bromophenol blue between steps by soaking the array in a 0.1% solution in DMF for 1 minute before rinsing and imaging. Following Fmoc and MeNPOC removal the sample was soaked in DMF for 5 minutes and rinsed. At the end of the synthesis the TMPP-Ac—OSu-Br was coupled by dissolving 30 mg (0.01 mmoles), 25 μL DIPEA (15 μmoles) in 375 μL DMF and reacting it overnight at 50° C.

### Example 9

### In Situ MALDI-MS Characterization of Photopolymer Array

Polymer microstructures were individually spotted with ˜1 μL of (1:1:1) solution of TEA, acetonitrile, and nanopure water and then allowed to dry. These are then individually spotted with ˜1 μL of a saturated solution of α-cyano-4-hydroxycinnamic acid dissolved in 50% acetonitrile, 0.1% TFA, and nanopure water. Samples are dried and the array is loaded into the MALDI-MS with a custom sample holder.

### Results and Discussion

Initial work developing peptide microarray technology followed the experimental methodology described by Fodor et al., Science 251:767-773, 1991. Here sequential light directed patterning steps were performed on silanized glass initially using a fluorescent dye to demonstrate spatial patterning and a monoclonal antibody against the peptide epitope YGGFL was used to demonstrate successful peptide synthesis of this peptide and by inference the rest of the array.

Though the initial dye patterning experiments were successful, this approach to peptide synthesis was essentially a trial and error approach. Here a number of steps were performed with no intermediate characterization, followed by antibody hybridization steps which ultimately resulted in a yes or no result, with no ability to troubleshoot the synthesis.

Ultimately, this approach was abandoned in favor of light directed synthesis using the photolabile group used by Fodor et al., 6-nitroveratryloxycarbonyl (NVOC) on solid phase synthesis resin in attempt to provide sufficient material for characterization via HPLC-MS. HPLC-MS led to the following observations: the stepwise yield even when using semicarbazide HCl as a scavenger for the dimethoxynitrosobenzaldehyde was ˜60% and there is the accumulation of a fluorescent side product which has enhanced absorption at 365 nm compared to the inherent absorbance of NVOC at this wavelength and has a broad emission spectrum centered at 500 nm.

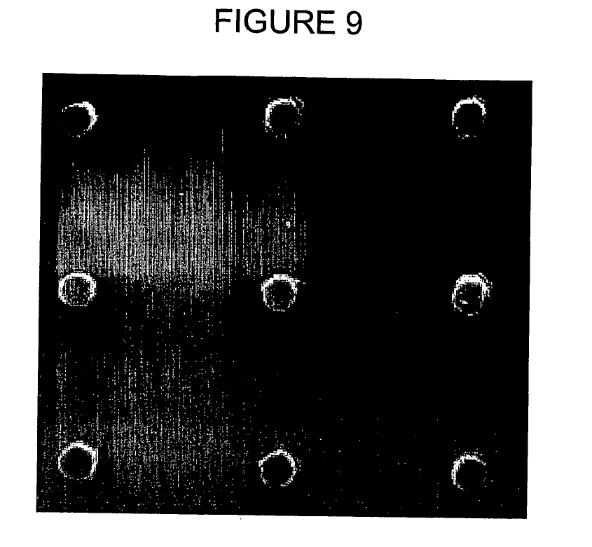

Given these serious synthetic issues, a new array format was developed which allows the in situ characterization of array elements using MALDI-MS. Here, array elements are comprised of high site density porous polymer gel microstructures which provide sufficient material for characterization (FIG. 9). This format has enabled the development of photolysis conditions which inhibit the formation of the colored side products that were found in the initial experiments.

The formulation and construction of porous polymer microstructures was not trivial. It was desired to construct mechanically stable and therefore highly cross-linked structures with large pores to facilitate diffusion. The internal sites of the microstructure should be accessible in a variety of solvents including DMF, which is used for the peptide synthesis and water which is used for binding studies. They should have a high site density to provide large amounts of affinity material for binding experiments. It was also desired to make a polymer with low fluorescence so that fluorescence can be used to assay peptide arrays.

This required simultaneous optimization of many interrelated properties. HEMA and EDMA were selected as monomers due to their low fluorescence, compatibility with the desired solvents, and the ability to make macropores using porogenic solvents (dodecanol and cyclohexanol). AIBN was used as a photoinitiator because its photoproducts are aliphatic and not expected to be fluorescent. A micromirror array provided a flexible means for obtaining polymer arrays. This same instrument was used for the photopatterning allowing for the correct registration of microstructures with the illumination source.

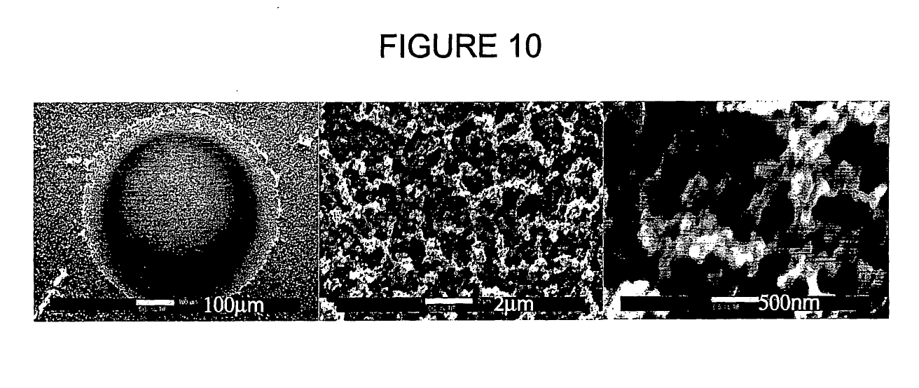

The resulting polymers were porous, swelled in water and DMF, had low fluorescence and high site densities of ˜1 nmole/feature. This was estimated from the absorbance of the fiberated dibenzofulvene-piperidine from the Fmoc-glycine grafted surface. Microstructures were initially made 100 μm tall (FIG. 9); however long reaction times and rinsing steps were required due to mass transfer limitations. Another concern was the long exposure time required to remove the photolabile protective group from thick microstructures due to shading effects. These problems were overcome by making very thin macroporous microstructures, as shown in FIG. 10.

These microstructures, as seen in FIG. 10, are estimated to be on order 10 μm thick. This coupled with the very porous structure seen in the SEM results in rapid mass transfer. The thin structures also have significant advantage over those shown in FIG. 9 in that they reduce internal shading problems that may reduce photodeprotection yield. The origin of the dark ring in the low magnification image is unknown. However, the pore structure at higher magnifications appears to be similar at the edges and in the center. The large pores should help facilitate diffusion and increase access to the internal sites within the polymer.

The high site density of the microstructures roughly 10⁶ more sites than a monolayer and offers several advantages. It is easy to see fluorescence using low cost detection methods, including by eye. The high site density also allows the use of convenient colorimetric tests (TNBS, ninhydrin test, and bromophenyl blue test) often used in solid phase synthesis to monitor coupling reactions. In addition, in situ characterization of the microarray using MALDI-MS can be perform as reported previously including the sequencing of peptides off the surface using post-source decay methods.

This high site density can allow the detection of materials that bind to the peptide array (e.g., from cell extracts) by using MALDI-MS. Given that the number of sites per microstructure is 10³-10⁶ more than the detection limits of MALDI-MS, it is reasonable to expect that low abundance ligands or those with weak binding constants can be detected using this approach.

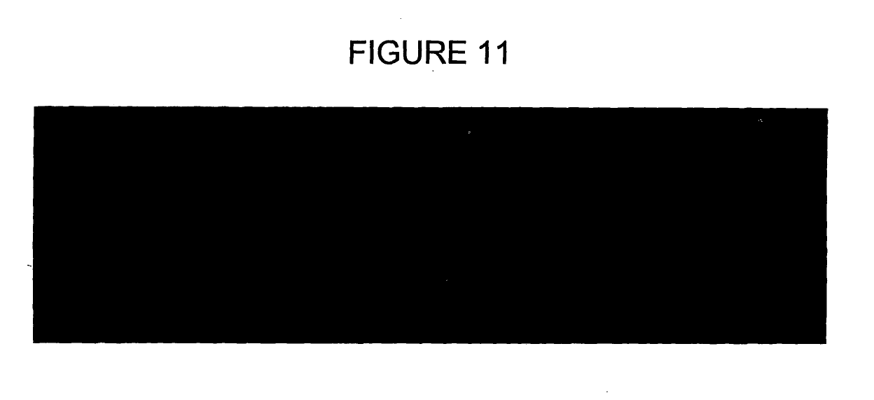

Initial light directed peptide synthesis on the polymer microstructures using the photolabile protective groups NVOC, NNPOC, and MeNPOC revealed low photolysis yields (˜60%) on the surface, and the accumulation of a stable yellow-orange colored product(s) as illustrated in FIG. 11. Photoproduct(s) were found to be more fluorescent then the protective group with broad absorption and emissions centered at ˜420 nm and ˜520 nm respectively. The formation of these products was found to be both acid and base catalyzed. Attempts to scavenge reactive photolysis products with semicarbazide HCl as reported in the literature were not successful (Kessler et al., Org. Lett. 5:1179-1181, 2003; Patchomik et al., J. Am. Chem. Soc. 92:6333-6335, 1970). In solution, photolysis in acidic conditions was found to be >90%, much greater than found for the same chemistry on the surface. This is most likely due to the high surface concentration of photolysis products compared to the rather low concentration of semicarbazide, which can be dissolved in DMF (˜100 mM). Ethanolamine was tested as a scavenger because it can be used in high concentration since it is a liquid which is miscible with DMF, acetonitrile, etc. However, photolysis under acid, basic, or neat ethanolamine resulted in the formation of a bright orange compound on the surface.

Ultimately, it was found that thin microstructures (˜10 μm) in conjunction with thiol scavanger (dithiotheitol (DTT) or β-mercaptoethanol) significantly reduced the formation of colored compound(s) on the surface and significantly increased deprotection yields. We are not aware of reports using β-mercaptoethanol (SME) as a scavenger. However, Barth reported using DTT as a scavenger far caged ATP studies and Rinnova who studied the use of DTT to scavenge photoproducts when cleaving photolinkers (Barth et al., J. Am. Chem. Soc. 119:4149-4159, 1997; Rinnova et al., J. Pept. Sci. 6:355-365, 2000).

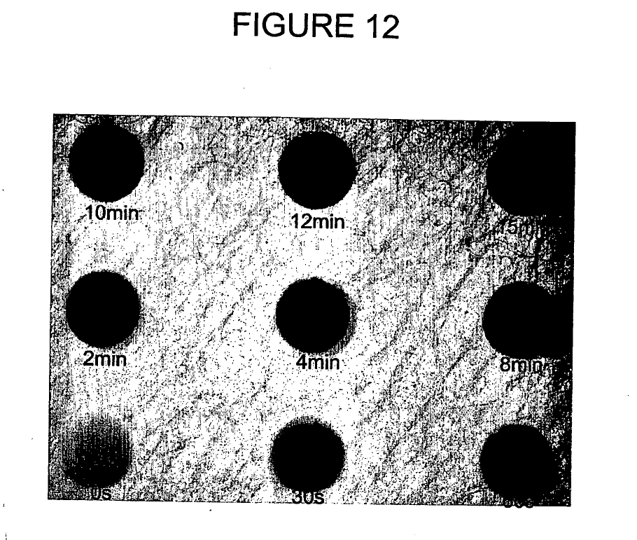

To determine the optimum exposure time for photocleavage, an array of 9 polymer microstructures were aminated with Fmoc-Glycine and the photolabile protective group MeNPOC was substituted for the Fmoc group on the microstructures. The microstructures were soaked in a 30% β-mercaptoethanol, 7% DIPEA, and DMF solution and radiated for times ranging from 0-15 minutes as shown in FIG. 12. These samples were then stained with bromophenol blue and imaged with a digital camera. The bromophenol blue turns blue and binds in the presence of primary amines and has been used to monitor surface amine concentration (Bier et al., Nucleic Acids Res. 27:1970-1977, 1999).

FIG. 12 shows that complete deprotection occurs within the first 12 minutes of exposure, the lack of color change in the unexposed microstructure reveals a high yield of the MeNPOC substitution reaction and that scattered light doesn't result in deprotection of adjacent features.

This substitution approach can be contrasted to previously reported approaches (Fodor et al., Science 251:767-773, 1991), which require the tedious preparation and purification of photoprotected monomers. Here, as illustrated in FIG. 8, commercially available Fmoc amino acids can be used and then protected in situ with the photolabile group.

This approach can be used in array construction, where areas are photodeprotected and reacted with the desired Fmoc amino acid. Once photolabile protective group has been removed and the desired Fmoc amino acids have been coupled to the entire layer, the MeNPOC can be substituted for the Fmoc group and the process is repeated. This means that it is only necessary to do the substitution once per layer, significantly reducing the additional steps required to use this method. For example, to make an array of decamers only 10 Fmoc substitutions would be required as opposed to 10× the number of amino acids in each layer (which is the number of photocleavage steps required).

This switching between photolabile and base labile protective groups can also reduce the effects of scattered light. If only photolabile groups are used, scattered light will integrate over all photodeprotection steps for a given layer reducing the overall yield where the effect will be reduced by introducing Fmoc amino acids after each photodeprotection.

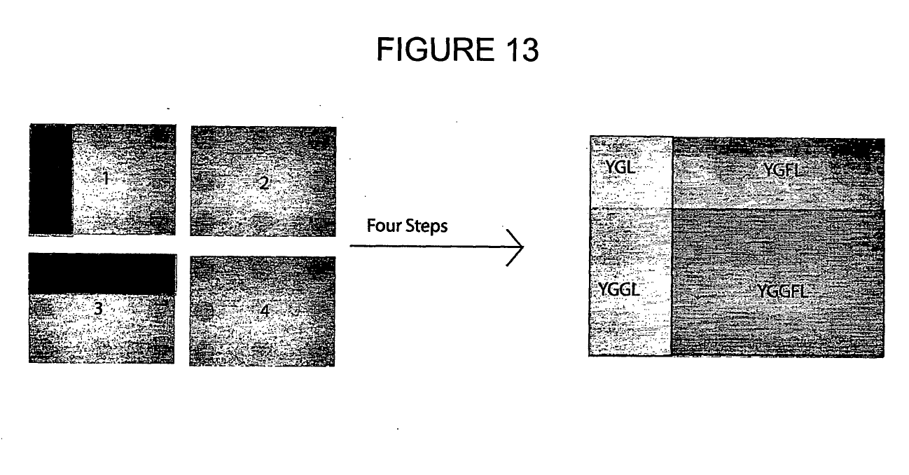

Light directed synthesis was used to construct an array of four peptides: YGL, YGGL, YGFL, YGGFL on nine polymer microstructures in four light directed steps as shown in FIG. 13.

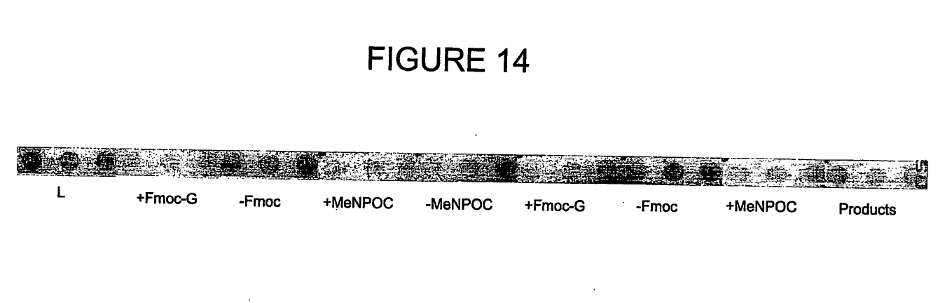

All couplings were monitored using a bromophenol blue (BPB) staining step. After each coupling, the BPB test was performed and the result photographed as shown in FIG. 14. The ability to monitor stepwise yield is an important tool in peptide synthesis. Inspection of FIG. 14 reveals that even the Fmoc steps do not appear to have quantitative yields, which may be a result of mass transfer problems. It also appears that there was a very low photodeprotection yield before the addition of the second glycine which accounts for a significant loss in the synthesis. These may be attributed to decreased swelling of the polymer following the attachment of several non polar amino acids.

FIG. 14 also reveals the significant decrease in free amines before adding the second glycine. This can be seen by comparing the color intensity of the microstructures before and after the addition and photolysis of MeNPOC from GL (third and fifth from the left respectively).

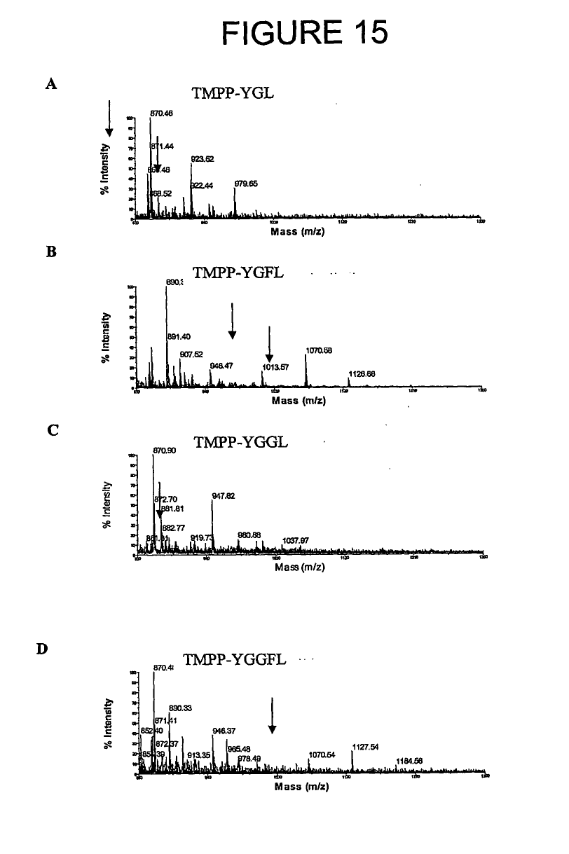

After the synthesis was complete, a N-terminal label N-Tris(2,4,6-trimethoxyphenyl)phosphonium (TMPP) was attached to improve ion detection. Microstructures were then spotted individually with TFA solution to cleave the acid labile linker and then matrix solution before loading the array into the MALDI-MS. In situ MALDI-MS was used to characterize the array. The results of which are shown in FIG. 15.

FIG. 15 shows that all the predicted peptides are present in their respective microstructures. TMPP-YGL 923.52 Da versus 923.38 Da predicted, TMPP-YGFL 1070.58 Da versus 1070.45 Da predicted, TMPP-YGGFL 980.88 Da versus 980.41 Da predicted, and TMPP-YGGFL 1127.54 Da versus 1127.47 Da predicted.

Several of the major ions are seen in all the spectra and do not appear to be peptides. The 970.4 Da peak has been seen before and is likely a matrix cluster. The identities of the 890.3 Da and 946 Da peaks are unknown but they may again be some sort of matrix cluster.

These spectra were calibrated using close external standards spotted adjacent to the microstructures and used for spectrum calibration. In particular, the common 970.4 Da peak can be used to gauge the calibration. Extracting this peak from FIG. 5A-D m/z for this peak is 870.46 Da, 870.45 Da, 870.90 Da, and 870.40 Da, respectively. This suggests a significant deviation in spectra 33C corresponding to TWPP-YGGL, if one were to shift the entire spectrum 0.4 Da to the left the 980.88 Da peak assigned to TMPP-YGGL would be much closer to its predicted value of 980.41 Da.

Interestingly, peptides containing the t-butyl protective group are also seen. TMPP-Y(tbut)GL 979.65 Da vs. 979.45 predicted and TMPP-Y(tbut)GFL 1126.66 Da vs. 1126.51 Da predicted-TWPP-Y(tbut)GGL and TMPP-Y(tbut)GGFL are also seen but are extremely low abundance ions.

Though it is not quantitative to compare ion counts between different ions, due to differences in sublimation, the fact that all peptides bear the same cationic TMPP and therefore are not as dependent on matrix ionization, can allow some qualitative comparisons to be made. It appears that there is significantly higher ion count for peptides TMPP-YGL (FIG. 15A) and TMPP-YGFL (FIG. 15B) than TMPP-YGGL (FIG. 15C) and TMPP-YGGFL (FIG. 15D). This follows what was observed in the BPB test which showed a low yield for the third photolysis step which was used to selectively add a second glycine to make peptides YGGL and YGGFL but not YFL and YGFL.

The mass spectra also reveal the presence of truncated peptides which account for some of the stepwise losses. The 866.46 Da peak in FIG. 15A is likely TMPP-YL (866.36 Da predicted). FIG. 15B reveals the presence of 1013.57 Da which is likely to be TWPP-YFL (1013.43 Da predicted). Inspection of FIG. 15D reveals the presence of the same 1070.54 Da peak corresponding to TMPP-YGFL which again makes sense given the low yield of the second Glycine deprotection. Two other truncations are apparent from these spectra, TMPP-YGL at 980.50 Da and TMPP-GGL at 964.46 Da (946.41 Da predicted) which is not labeled however it is the larger peak next to the left of its second isotopic peak 965.68 Da which is labeled.

### Example 10

### Fluorescence Imaging of Microdomain Array

A heteropolymer element, a 12 residue peptide, was attached to a porous polymer substrate and the spacer was acylated glycine attached to a porous polymer. This Example demonstrates automated peptide synthesis, microdomains which are composed of peptide surrounded by less polar acylated spacer, protein binding to the array, and fluorescent imaging of the array.

Materials: 3-(trimethoxysilyl)propyl methacrylate were from Fluka GmbH (Buchs, Switzerland). N,N-Dimethylformamide (DMF) was from Applied Biosystems Inc. (Foster City, Calif.). Azo-bis-isobutyronitrile (AIBN), β-mercaptoethanol, piperidine, dichloromethane (DCM), polyvinylacetate (PvAc), diethylene glycol dimethyl ether (diglyme), Trifluoroacetic acid (TFA), Bovine Serum Albumin (BSA) and diisopropylethylamine (DIPEA) were from Sigma-Aldrich Chemical Co. (Milwaukee, Wis.). 40 mm diameter glass coverslips were from Bioptechs (Butler, Pa.), 1“X3” microscope slides were from VMR (West Chester, Pa.). ((α-methyl-2-nitropiperonyl)oxy)carbonyl chloride (MeNPOC—Cl) Cambridge Major Laboratories Inc. (Germantown Wis.). Acetonitrile and bromophenol blue were from Alfa Aesar (Ward Hill, Mass.). Methanol, sulfuric acid, hydrochloric acid were purchased from Mallinckrodt Inc. (Paris, Ky.). FMOC amino acids and O-(7-Azabenzotriazol-1-yl)-N,N,N′,N′-tetramethyluroniumhexafluorophosphate (HATU) were purchased from Anaspec Inc. (San Jose, Calif.). Water was purified using a NANOPure ultrapure filtration system from Barnstead. (Dubuque, Iowa). Tween-20 was obtained from USB (Cleveland, Ohio). Cy-5 labeled GAL80 protein was a generous gift from Dr. Stephen Johnston.

Equipment: Spin-coating was done using a Laurell (North Wales, Pa.) WS-400B-6NPP-LITE spin processor. An FCS2 flow chamber from Bioptechs Inc. (Butler, Pa.) was used for all reactions. Patterning was performed using a SF-100 micromirror array from Intelligent Micro Patterning, LLC, (St. Petersburg, Fla.). Peptide synthesis was done using a Milligen 9050 peptide synthesizer, Millipore Co. (Bedford, Mass.). Confocal microscopy was performed using a Zeiss (Oberkochen, Germany) confocal microscope. Fluorescence images of peptide microdomain arrays were obtained using a PerkinElmer (Wellesley, Mass.) ScanArray ExpressHT.

### Fabrication of Polymer Structures.

Glass gurface functionalization was done as described above.

Method 1. Microdomains were made following technique described above for forming microstructures with the exception that a film was formed using a continuous illumination of a roughly 1 cm² area which was then sheared to form a thin film on order of 25 microns thick.

Method 2. Polymer structures were made on a thin film using a spin-coating procedure. Monomer solutions containing 10%, 12%, 15%, 20%, 30%, 40%, 50% 1:3 HEMA:EDMA and 90%, 88%, 85%, 80%, 70%, 60%, 50% low-volatility porogenic solvent (6% 113 kDa PvAc or 2% 500 kDa PvAc in diglyme) respectively were spin-coated for 30 seconds at 2,000 rpm on a 40 nm diameter glass slide or a 1“X3” glass microscope slide. The monomer solution composed of 12% 1:3 HEMA:EDMA and 88% low-volatility porogenic solvent gave the best surface porosity and durability characteristics and the resulting films were used for the synthesis of peptide microdomains surrounded by acetylated glycine spacers. Spin-coated film thickness was shown to be on the order of 5-8 microns thick by confocal fluorescence microscopy, depending on the spin-coating conditions used.

### Synthesis on Polymer Structures.

Methods described above were used with the exception that an automated system was used to construct the peptides. This system was comprised of a Milligen 9050 peptide synthesizer complete with autosampling system, a bioptics FS2 flow through optical chamber, a intelligent micropatterning SF-100 micromirror array, a computer controlling the synthesizer (slave) with custom protocols for constructing the heteropolymer arrays, and a master computer with custom software for creating masks, displaying the masks for a specified duration, and triggering the peptide synthesizer and waiting for a signal from the synthesizer to indicate completion of a synthetic step.

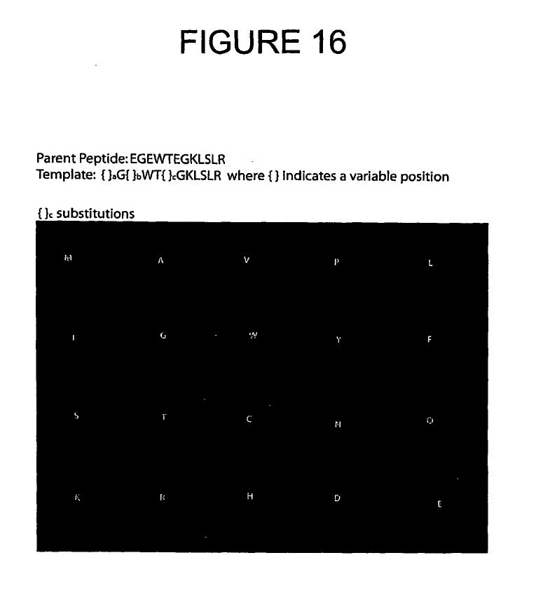

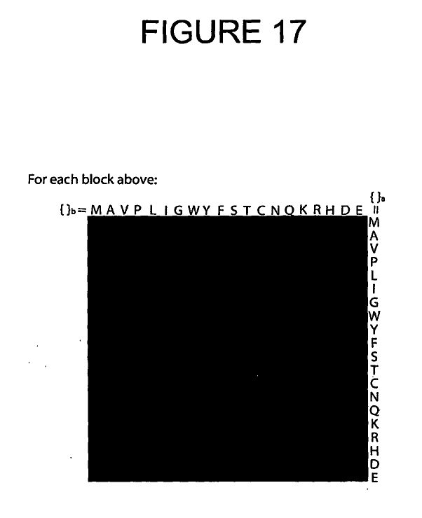

8,000 unique peptide microdomains were synthesized on a thin film in a 100×80 feature array format (FIG. 16) using the automated system. The peptides contained within the microdomains were 8,000 variants of a 12-mer peptide known to bind the transcription factor GAL80 (amino acid sequence: EGEWTEGKLSLR). Previous studies showed three amino acid residues positions 1, 3, 6 from the left) in the peptide were particularly important for GAL80 affinity. These three positions were selectively substituted in order to generate all possible peptides containing the 20 natural amino acids in these positions, resulting in a total of 8,000 unique peptide sequences (20³) (FIG. 17).

### Post Synthesis Modification.

A final illumination of the entire array in photolysis solution removes the photolabile protective group from spacer areas. The spacer areas are then chemically modified by soaking the thin film a solution of acetic anhydride, Dimethylamino pyridine, and DMF for 20 minutes. Finally, acid labile side-chain protective groups are removed with a 1 hr soak in a solution of 95% Trifluoroacetic acid, 2.5% water, and 2.5% triisopropyl silane.

### Protein Binding to Array.

To prepare the peptide microdomain array for GAL80 binding, the thin film was washed and soaked in aqueous buffer solution (1×PBS pH 8.0) for 2 hours with several buffer exchanges during that period. The buffer solution was then poured off and a predetermined volume of buffer solution (1×PBS pH 8.0) containing blocking agent (3% BSA, 0.02% Tween-20) was added and soaked for 1 hour at 4° C. After 1 hour an appropriate volume of concentrated Cy5-GAL80 sample was added to the buffer containing blocking agent to give a final GAL80 concentration of 5 nM. The array was soaked in the protein binding solution for 12 hours at 4° C. on a gentle rocking table. After binding, the array was washed several times with 1×PBS buffer then soaked for 6 hours in 1×PBS with several buffer exchanges during that period.

### Fluorescence Imaging of Array.

To prepare the microdomain array for imaging, the thin film was washed with nanopure water to remove salt on the surface that may affect imaging then dried with a low nitrogen stream. The array was imaged using a PerkinElmer imager with standard excitation laser settings for Cy5 dye, 5 micron resolution and the PMT set at 43%. The resulting array image is shown in FIGS. 16 and 17. Distinct GAL80 binding to the peptide microdomains is clearly visible in the 5 micron resolution images (FIGS. 16 and 17).

### Example 11

### In Situ MALDI-MS Identification of DNA Binding Protein Using Porous Polymer Affinity Materials

A micromirror array has been used to construct arrays of polymer microstructures directly from a solution of 2-aminoethyl methacrylate, trimethylolpropane ethoxylate (14/3 EO/OH) triacrylate, AIBN, and cyclohexanol. These high site density polymer hydrogels provide were used as a substrate for covalently bound DNA containing three repeats of the consensus sequence for the transcription factor AP-1 (c-JUN). 5′ amino labeled DNA was immobilized on polymer structures activated with N,N′-Disuccinimidyl carbonate. A complimentary with a 5′ TexasRedX fluorophore was hybridized to the immobilized DNA resulting in brightly fluorescent structures that can be seen by eye. These structures were soaked in a solution containing rhAP-1 and washed. Trypsin was spotted onto each of the microstructures and each of the microstructures were characterized in situ using MALDI-MS. Peptide fragments were observed in the microstructures with AP-1 and not in the control. The SwisProtein databank was searched to match these peptides using PROTEIN PROSPECTOR resulting 10 of the 41 ions being matched as tryptic fragments of rhAP-1. In principle these microstructures can be derivatized with many types of protein affinity materials and used with MALDI-MS to identify the protein with which they interact.

Materials: Glass coverslips were from Bioptechs (Butler, Pa.). 6-nitroveratryloxycarbonyl chloride (NVOC—Cl) and 3-(trimethoxysilyl)propyl methacrylate were from Fluka GmbH (Buchs, Switzerland). N,N-Dimethylformamide (DMF) was from Applied Biosystems Inc. (Foster City, Calif.). Trimethylolpropane trimethacrylate (TRIM), 2-aminoethyl methacrylate, poly(ethylene glycol)dimethacrylate, trimethylolpropane ethoxylate (14/3 EO/OH) triacrylate, and 8 ml cyclohexanol, azo-bis-isobutyronitrile (AIBN), piperidine, 1,4-dioxane, semicarbazide hydrochloride, diisopropylethylamine (DIPEA), proteomics grade trypsin, Hepes, dithiothreitol, glycerol, nonidet P-40, potassium chloride, Tris-HCl, EDTA, Sodium Chloride, N,N′-disucinimidylcarbonate (DSC), and triisopropyl silane (TIS) were purchased from Sigma-Aldrich Chemical Co. (Milwaukee, Wis.). Isopropanol and ethanol (95%) were from ACROS Organics (Geel, Belgium). Acetonitrile was from Alfa Aesar (Ward Hill, Mass.). Methanol, hydrogen peroxide (30%), sulfuric acid, hydrochloric acid were purchased from Mallinckrodt Inc. (Paris, Ky.). Fmoc-Glycine, Fmoc-Phenylalanine, Fmoc-Leucine, 2-(1H-benzotriazole-1-yl)-1,1,3,3-tetramethyluronium hexafluorophosphate (HBTU) and Trifluoracetic acid (TFA), were from Advanced ChemTech Inc. (Louisville, Ky.). Fmoc-Rink amide linker was from NovaBiochem, a division of EMD Biosciences, Inc. (San Diego, Calif.). Water was purified using a NANOPure ultrapure filtration system from Barnstead. (Dubuque, Iowa). TMPP-acetic acid N-hydroxysuccinimide ester (TMPP-Ac—OSu-Br) was prepared following the method described by Huang et al.¹³ The mass spectrometry matrix □-cyano-4-hydroxycinnamic acid was from Aldrich Chemical Co. (Milwaukee. WI). AP1 and NFkB (p65) were purchased from Promega Corp (Madison, Wis.). DNA oligonucleotides, 5′-AMINO-PEG9-CGC TTG ATG AGT CAG CCG GAA CGC TTG ATG AGT CAG CCG GAA CGC TTG ATG AGT CAG CCG GAA GCT TCC GGT AAA TTT and 5′-Texas Red-AAA TTT ACC GGA AGC TTC CGG CTG ACT CAT CAA GCG TTC CGG CTG ACT CAT CAA GCG TTC CGG CTG ACT CAT CAA GCG were purchased from IDT (Coralville, Iowa).

Equipment: An FCSII flow chamber from Bioptechs Inc. (Butler, Pa.) was used for all reactions. Patterning was performed using a SF-100 micromirror array from INTELLEGENT MICRO PATTERNING, LLC, (St. Petersburg, Fla.). Peptide synthesis was performed on a Milligen 9050 peptide synthesizer, Millipore Co. (Bedford, Mass.). Mass spectrometry was performed using a Voyager-DE STR MALDI-TOF mass spectrophotometer, Applied Biosystems Inc. (Foster City, Calif.). Spectrophotometry was done using a Cary 50 UV-Vis spectrophotometer, Varian Inc., (Palo Alto, Calif.). Scanning electron microscopy (SEM) was performed using a XL30ESEM environmental SEM, FEI Co. (Hillsboro, Oreg.) on a sample coated with 3.5 nm palladium/gold with acceleterating volatages of 3-10 KV. Software used for peptide mass finger printing was Protein Prospector, UCSF (San Francisco, Calif.).

### Construction of Polymer Microstructure Arrays

Photopolymer gel structures were prepared covalently bound to silanized coverslips. The coverslips were prepared as described previously¹⁴. Microstructures were made by the direct photopolymerization of a solution of 60 mg 2-amino ethyl methacrylate, 560 mg trimethylolpropane ethoxylate (14/3 EO/OH) triacrylate, 9.7 mg azo-bis-isobutyronitrile, 1188 mg cyclohexanol. Nitrogen is bubbled through the solution for 10 minutes to remove oxygen before loading it into a nitrogen purged flow cell with a methacrylate functionalized glass slide and a 250 □m thick gasket separating the coverslip from the upper glass slide. The resin is polymerized using a micromirror array with a 380/50 nm bandpass filter for 13 minutes at an intensity of 54 mW/cm² and rinsed with methanol and DMF to remove unpolymerized monomer.

### DNA Immobilization on Polymer Microstructures

Two slides were rinsed with acetonitrile and reacted with a solution of 102.5 mg N,N′-Disuccinimidyl carbonate, 66.1 uL of diisopropylethylamine in 8 mL of anhydrous acetonitrile for 4 hrs at RT. These were then washed with DME, DCM, and the placed in a hybridization chamber. 10 uL of 556 uM of the oligo 5′-AMINO-PEG9-CGC TTG ATG AGT CAG CCG GAA CGC TTG ATG AGT CAG CCG GAA CGC TTG ATG AGT CAG CCG GAA GCT TCC GGT AAA TTT bearing three repeats of the AP1 binding sequence were mixed with 111 uL of 30 mM Tris-HCl buffer 100 mM in NaCl pH˜8 was spotted onto three of the features, the other features were spotted with a 150 uM solution of bisaminopropoxybutane in water and allowed to react overnight at 37 C. The DNA spots were then spotted with the 150 uM bisaminopropoxybutane solution and allowed to react for ˜1 hr. These were then washed with the same tris-HCl buffer and 4 uL of 3 μM 5′-Texas Red-AAA TTT ACC GGA AGC TTC CGG CTG ACT CAT CAA GCG TTC CGG CTG ACT CAT CAA GCG TTC CGG CTG ACT CAT CAA GCG and allowed to hybridize for 1.5 hrs at RT. This was again washed with the same tris-HCl buffer and imaged for fluorescence and TE buffer (100 mM Tris HCl pH 7.6, 1 mM EDTA) and left at 4 C for 48 hrs. Only the spots with the covalently bound oligo were fluorescent.

### Protein Binding and In Situ Digestion on DNA Grafted Polymer Microstructures

This array was then washed with sterile water and a 1:1 mixture of rhAP1 protein 0.3 ug/ml and buffer Z (25 mM HEPES K+ pH 7.8, 12.5 mM MgCl2, 1 uM DTT, 20% glycerol, 0.1 Nonidet p40) and 2 uL was spotted onto all 5 microstructures. This was allowed to bind for 0.5 hrs at RT and 2 hrs at 4 C and then rinsed with sterile water at 4 C. The fluorescence was rechecked and the treatment spots were still fluorescent. 2 uL of a 1:100 dilution of 10 ug/mL trypsin in 25 mM ammonium carbonate and sterile water was spotted onto one feature and the array was left at 37 C overnight.

MALDI-MS Characterization of Peptide Fragments from Microarray

A slightly subsaturated solution of alpha-Cyano-4-hydroxycinnamic acid solution of 1:2 acetonitrile:water with 1% TFA was spotted, 2 uL per feature on to the array and left in hybridization chamber for 45 min. This was then dried and spotted with 1 uL of a saturated solution of alpha-Cyano-4-hydroxycinnamic acid in 1:1 acetonitile:water with 0.1% TFA. This was loaded into the Applied Biosystems Voyager-DE STR MALDI-MS using a custom holder and the mass spectra was collected. A reflectron 2500 method was used where the delay time was adjusted to give highest ion count, typically 700 ns was used. The 41 highest intensity peaks were selected and entered into the program Protein Prospector. This software was set up as follows: single cleavage, mass tolerance of 300 ppm, cysteine unmodified, monoisotopic, single cleavage, species: Homo Sapiens, mass range from 1-100 kD, and the SwissProt.r36 database was searched.

### Results and Discussion

Photopolymerization resulted in 250 μm tall and 500 μm diameter porous microstructures with their corresponding numbers on the upper surface. Here, the surface of the microstructures has a slightly checkered pattern resulting from the small gap between the micromirrors. It can also be noted that the base of the microstructure has a much larger diameter then the top, for the most part this is a result of the shrinkage of the microstructure in are, where the dimensions on the glass are constrained. In air these microstructures are clear, however, they turn white in DMF, reflecting the expansion of pores when the polymer swells.

A simple colorimetric test using TNBS was performed to confirm the presence of amino groups. This spot turned bright orange indicating the presence of primary amines. The simple fact that a color change is clearly visible by eye indicates the very high concentration of amino groups within the polymer. Estimates based on the dibenzofulvene-piperidine adduct absorption at 301 nm Fmoc protective group released from during peptide synthesis studies on these structures indicate ˜50 nmole/feature (data to be reported elsewhere).

These microstructures were then activated using DSC, the DNA was immobilized and the surface was then passivated with ethanolamine. A fluorescently labeled complimentary was hybridized and the microstructures were then washed. Alternatively, dsDNA also be immobilized directly onto the surface. All spots were treated with the complimentary AP1 DNA labeled with Texas Red-X dye. Green excitation light is from a overhead lamp filtered through a D560/40 filter, emission was clearly visible by eye and was imaged using a Nikon CoolPix775 digital camera with a D630/60M filter in front of the lens. It is very clear that the treated samples are fluorescent and the remaining spots are not.

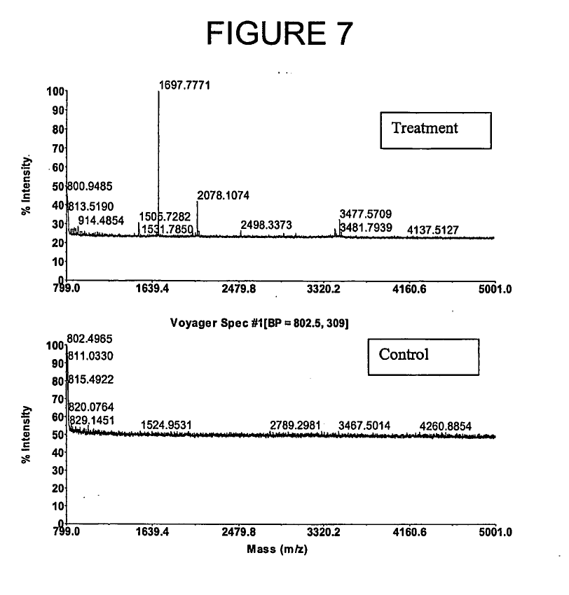

This array was then washed with sterile water and a 1:1 mixture of rhAP1 protein 0.3 ug/ml and buffer Z and allowed to bind for 0.5 hrs at RT and 2 hrs at 4 C and then rinsed with sterile water at 4 C. The fluorescence was rechecked and the treatment spots were still fluorescent. An In situ trypsin digest was performed and a slightly subsaturated solution of alpha-Cyano-4-hydroxycinnamic acid matrix solution was spotted onto each feature. This was then dried and loaded into the Applied Biosystems Voyager-DE using a custom holder and the mass spectra was collected. The spectra from the AP1 region and the Control region are shown in FIG. 7.

The 41 ions areas greater then 100 were selected and entered into the program Protein Prospector (UCSF): 1697.778, 2077.124, 3476.733, 1505.739, 2031.98, 817.468, 914.4895, 2497.337, 949.5104, 845.5007, 814.1445, 877.0493, 2094.13, 1679.773, 3494.551, 889.5275, 2923.321, 2076.047, 3355.565, 861.4817, 1736.816, 1103.621, 841.0656, 1521.769, 1681.562, 933.556, 815.1593, 2092.081, 2148.118, 1460.781, 3492.687, 2958.74, 3434.513, 3474.65, 2390.361, 3435.98, 3478.618, 3387.657, 3410.752, 2446.184, 3917.162 (m/z).

This program compared these peptides with the SwissProtein database which matched 10 out of the 41 ions as peptide fragments predicted for hrAP1 digested with trypsin giving a MOWSE score of 1.18e+007. The ions matched were: 914.4895, 1505.7393, 1521.7691, 1697.7784, 2076.0471, 2077.1235, 2497.3374, 2923.3210, 3476.7328, 3492.6867.

### CONCLUSION

Consensus DNA covalently bound to polymer microstructures have been used as affinity substrates to bind the transcription factor AP-1. These materials have such high site density that colometric tests can be clearly seen by eye as can the fluorescence from fluorescently labeled complimentary DNA.

In situ trypsin digestion coupled with MALDI-MS has yielded peptides which were used to search the SwissProt databank to determine the identity of the transcription factor as rhAP-1. This shows the utility of polymer microstructures as affinity substrates.

Thus, a variety of affinity material including DNA, RNA, aptamers, peptides, proteins, and antibodies can be attached to the structures. This format can be used to fish for proteins of interest in solution. Since, the peptide fragments are analyzed post-translational modifications of proteins can be identified. The high site density of the polymer microstructure can capture low abundance proteins or those with small binding constants. The direct trypsin digestion and in situ MALDI-MS provides a very flexible method of analysis which has broad proteomics applications.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

What is claimed is:

1. A microarray, comprising:
a. a substrate; and
b. a plurality of three-dimensional microstructures formed on the substrate, each three-dimensional microstructure being made with polymer material and having a plurality of reactive sites formed on a surface of the three-dimensional microstructure.

2. The microarray of claim 1, wherein the three-dimensional microstructure increases surface area and density of the reactive sites on the surface of the three-dimensional microstructure.

3. The microarray of claim 1, wherein the three-dimensional microstructure have dimensions of less than about 1 mm.

4. The microarray of claim 1, wherein the reactive sites are present in a surface density of from about 100 cm⁻² to about 10⁶ cm⁻².

5. The microarray of claim 1, wherein the majority of the reactive sites are present on the interior of the polymer material.

6. The microarray of claim 1, wherein the polymer material is a polymer gel.

7. The microarray of claim 1, wherein the polymer material is porous on an or part of the surface of the three-dimensional microstructure.

8. The microarray of claim 1, further comprising a plurality of chemical groups, respectively, attached to the reactive sites on the surface of the three-dimensional microstructure, each chemical group including at least one monomer.

9. The microarray of claim 8, wherein a first one of the plurality of chemical groups has a first chemical structure and a second one of the plurality of chemical groups has a second chemical structure different from the first chemical structure.

10. The microarray of claim 9, wherein the first chemical structure has an affinity for a first analyte and the second chemical structure has an affinity for a second analyte.

11. The microarray of claim 8, wherein the plurality of chemical groups comprises two or more microdomains, wherein a first one of the microdomains comprises a first plurality of chemical groups having a first chemical structure, and wherein a second one of the microdomains comprises a second plurality of chemical groups having a second chemical structure different from the first chemical structure.

12. The microarray of claim 1, wherein a microchannel is formed around at least one of the plurality of three-dimensional microstructures.

13. A method of making a microarray, comprising the steps of:
a. providing a substrate; and
b. disposing a plurality of three-dimensional microstructures on the substrate, each three-dimensional microstructure being made with polymer material and having plurality of reactive sites formed on a surface of the three-dimensional microstructure.

14. The method of claim 13, wherein the disposing step comprises at least one of photolithography, electropolymerization, spotting, stamping, printing, or selective polymerization or a combination thereof.

15. The method of claim 13, wherein the three-dimensional microstructure increases surface area and density of the plurality of reactive sites on the surface of the three-dimensional microstructure.

16. The method of claim 13, wherein one type of polymer material is polymer gel.

17. The method of claim 13, wherein the polymer material is porous on all or part of the surface of the three-dimensional microstructure.

18. The method of claim 13, further comprising attaching a plurality of chemical groups, respectively, to the reactive sites on the surface of the three-dimensional microstructure, each chemical group including at least one monomer.

19. The method of claim 13, further comprising the steps of:
a. attaching on a reactive site a first one of the plurality of chemical groups with a first chemical structure; and
b. attaching on a further reactive site a second one of the plurality of chemical groups with a second chemical structure.

20. The method of claim 13, further comprising the step of forming a microchannel around at least one of the plurality of three-dimensional microstructures.

21. A microarray, comprising:
a. a substrate;
b. a plurality of microdomains formed on the substrate, each microdomain being made with polymer material and having a plurality of reactive sites formed on a surface of the microdomain; and
c. an interstitial region surrounding each microdomain.

22. The microarray of claim 21, wherein the microdomains are three-dimensional microstructures.

23. The microarray of claim 21, wherein the reactive sites are present in a surface density of from about 100 cm⁻² to about 10⁶ cm⁻².

24. The microarray of claim 21, wherein the majority of the reactive sites are present on the interior of the polymer material.

25. The microarray of claim 21, wherein the interstitial regions comprise physical barriers.

26. The microarray of claim 21, wherein a first one of the plurality of microdomains comprises a first plurality of chemical groups having a first chemical structure, and wherein a second one of the plurality of microdomains comprises a second plurality of chemical groups having a second chemical structure different from the first chemical structure.

27. The microarray of claim 21, wherein the interstitial region comprises at least one of glass, silanized glass, silicon, silanized silicon, metal, porous or nonporous polymers, cells, tissues, or a mixture thereof.

28. The microarray of claim 21, wherein the porous polymer material increases surface area of the microdomains and density for the reactive sites on the surface of the microdomains.

29. The microarray of claim 21, wherein one type of porous polymer material is porous polymer gel.

30. The microarray of claim 21, wherein the interstitial region forms a virtual well by using nonpolar groups in interstitial areas to prevent wetting by polar fluids.

31. The microarray of claim 21, wherein the interstitial region forms a virtual well by using polar groups in interstitial areas to prevent wetting by nonpolar fluids.

32. The microarray of claim 21, wherein the interstitial region acts as a buffer zone to reduce the effects of scattered light, creates a diffusion barrier between the reactive sites of one microdomain and the reactive sites of another microdomain, acts as a chromatography material, scavenges reactive groups produced during synthesis, acts as a calorimetric indicator, acts as a fluorescence quencher, acts as a electrochemical scavenger, or acts as a laser desorption surface, or a combination thereof.

33. The microarray of claim 21, further comprising a plurality of chemical groups, respectively, attached to the reactive sites on the surface of the microdomains, each chemical group including at least one monomer.

34. The microarray of claim 33, wherein a first one of the plurality of chemical groups has a first chemical structure and a second one of the plurality of chemical groups has a second chemical structure.

35. The microarray of claim 21, wherein the plurality of microdomains comprise heteropolymer elements and the interstitial region comprises a nonpolar element.

36. The microarray of claim 35, wherein the heteropolymer elements are peptides attached to a porous polymer and the nonpolar element is an acylated glycine attached to the same porous polymer film.

37. The microarray of claim 35, wherein the heteropolymer elements are peptides and the nonpolar element is a fluorinated material.

38. A method of making a microarray, comprising the steps of:
a. providing a substrate;
b. disposing a plurality of microdomains on the substrate, each microdomain being made with polymer material and having a plurality of reactive sites formed on the polymer, wherein the reactive sites of the microdomain are surrounded by an interstitial region that lacks reactive sites;
c. attaching a plurality of chemical groups to the reactive sites, each chemical group including at least one monomer; and
d. optionally binding a nonpolar material at the interstitial region.

39. The method of claim 38, wherein the disposing step comprises at least one of photolithography, electropolymerization, spotting, stamping, printing, or selective polymerization or a combination thereof.

40. The method of claim 38, wherein the polymer material is polymer gel.

41. The method of claim 38, wherein the polymer material is porous on all or part of the surface of the three-dimensional microstructure.

42. The method of claim 38, further comprising the steps of:
a. attaching on a reactive site a first one of the plurality of chemical groups with a first chemical structure; and
b. attaching on further reactive site a second one of the plurality of chemical groups with a second chemical structure.

43. The method of claim 42, wherein the first one of the plurality of chemical groups is provided in a first microdomain and the second one of the plurality of chemical groups is provided in a second microdomain that is different from the first microdomain.

44. The method of claim 38, further comprising the step of forming a microchannel around at least one of the plurality of three-dimensional microstructures.

45. A method for characterization of microarrays comprising the steps of:
a. providing a substrate bearing a plurality of microdomains formed on the substrate,
i. each microdomain being made with polymer material and having a plurality of reactive sites formed on the polymer, and
ii. wherein at least one of the plurality of microdomains comprises a first plurality of chemical groups having a first chemical structure and bound to at least a portion of the plurality of reactive sites;
b. optionally contacting the first plurality of chemical groups having a first chemical structure with a species having an affinity for the first chemical structure;
c. releasing at least a portion of the first plurality of chemical groups from the plurality of reactive sites; and
d. characterizing the released chemical groups

46. The method of claim 45, wherein the releasing step comprises trypsinization.

47. The method of claim 45, further comprising the step of analyzing the species having an affinity for the first chemical structure.

48. The method of claim 45, further comprising the step of analyzing at least a portion of the first plurality of chemical groups prior to the releasing step.

49. The method of claim 46, wherein the analyzing step comprises at least one of absorbance spectroscopy, fluorescence spectroscopy, colorimetry, FTIR, RAMAN, SPR, circular dichroism or a combination thereof.

50. The method of claim 49, wherein the analyzing step further comprises modification of the chemical groups selected from reaction with a fluorescent tag, reaction with an absorbance tag, reaction with a radiolabeled tag, and reaction with an electrochemical tag.

51. The method of claim 49, wherein the analyzing step further comprises modification of the chemical groups selected from reaction with a secondary tag selected from a secondary antibody, a stain, and a ligand that specifically or nonspecifically binds to an analyte.

52. The method of claim 45, wherein at least a portion of the microdomains comprise three-dimensional microstructures.

53. The method of claim 45, wherein at least a portion of the microdomains are positioned on three-dimensional microstructures.

54. The method of claim 45, wherein two or more microdomains are positioned on one three-dimensional microstructure.

55. The method of claim 45, wherein the releasing step is performed with a laser and the characterizing step is performed with mass spectrometry.

56. The method of claim 45, wherein the array is characterized via MALDI-MS.

57. The method of claim 45, where the array is characterized via multiple analytical techniques.

58. The method of claim 45, where the array is characterized via microanalytical devices.

59. The method of claim 58, wherein the one microanalytical device is a microcantilever.

60. The method of claim 45, where the microstructures comprise at least one polymer.

61. The method of claim 45, where the microstructures comprise a polymer gel.

62. The method of claim 45, where peptide mass finger-printing is used to characterize the array.

63. The method of claim 45, where MALDI-MS is used to characterize materials bound or having interacted with the array.

64. The method of claim 45, where the chemical groups comprise at least one of DNA, RNA, aptamers, peptides, proteins, sugars, or are cells.

65. The method of claim 45, where the array is made by a photochemical method, an electrochemical method, a chemical method, or by a spotting or printing method.

66. A solid phase synthesis resin comprising a polymer material having a low fluorescence and low optical absorbance from about 300 nm to about 650 nm and bearing microdomains with interstitial region surrounding each microdomain, or three-dimensional microstructures, or a combination thereof, wherein a plurality of reactive sites is present on each microdomain or microstructure.

67. The resin of claim 66, wherein the polymer material comprises a porous polymer, a crosslinked porous polymer, or a polymer gel.

68. The resin of claim 66, wherein the reactive sites are present in a surface density of from about 100 cm⁻² to about 10⁶ cm⁻².

69. The resin of claim 66, wherein the majority of the reactive sites are present on the interior of the polymer material.


SEQUENCE LISTING (21 sequences)

SEQ ID NO: 1 - protein, 10 aa, Homo sapiens
KLASPELERL

SEQ ID NO: 2 - protein, 16 aa, Homo sapiens
KAQNSELASTANMLRE

SEQ ID NO: 3 - protein, 16 aa, Homo sapiens
KAQNSELASTANMLRE

SEQ ID NO: 4 - protein, 17 aa, Homo sapiens
KNVTDEQEGFAEGFVRA

SEQ ID NO: 5 - protein, 21 aa, Homo sapiens
KQSMTLNLADPVGSLKPHLRA

SEQ ID NO: 6 - protein, 21 aa, Homo sapiens
KQSMTLNLADPVGSLKPHLRA

SEQ ID NO: 7 - protein, 25 aa, Homo sapiens
RLIIQSSNGHITTTPTPTQFLCPKN

SEQ ID NO: 8 - protein, 28 aa, Homo sapiens
KEEPQTVPEMPGETPPLSPIDMESQERI

SEQ ID NO: 9 - protein, 33 aa, Homo sapiens
RLQALKEEPQTVPEMPGETPPLSPIDMESQERI

SEQ ID NO: 10 - protein, 33 aa, Homo sapiens; identical to SEQ ID NO: 9

SEQ ID NO: 11 - protein, 4 aa, Artificial Sequence
  Description of Artificial Sequence Synthetic peptide
GGFL

SEQ ID NO: 12 - protein, 4 aa, Artificial Sequence
  Description of Artificial Sequence Synthetic peptide
YGFL

SEQ ID NO: 13 - protein, 4 aa, Artificial Sequence
  Description of Artificial Sequence Synthetic peptide
YGGL

SEQ ID NO: 14 - protein, 5 aa, Artificial Sequence
  Description of Artificial Sequence Synthetic peptide
YGGFL

SEQ ID NO: 15 - DNA, 78 bp, Artificial Sequence
  Description of Artificial Sequence Synthetic oligonucleotide
cgcttgatgagtcagccggaacgcttgatgagtcagccggaacgcttgatgagtcagccggaagcttccggtaaattt

SEQ ID NO: 16 - DNA, 78 bp, Artificial Sequence
  Description of Artificial Sequence Synthetic oligonucleotide
aaatttaccggaagcttccggctgactcatcaagcgttccggctgactcatcaagcgttccggctgactcatcaagcg

SEQ ID NO: 17 - protein, 4 aa, Artificial Sequence
  Description of Artificial Sequence Synthetic peptide
YGFL

SEQ ID NO: 18 - protein, 4 aa, Artificial Sequence
  Description of Artificial Sequence Synthetic peptide
YGGL

SEQ ID NO: 19 - protein, 5 aa, Artificial Sequence
  Description of Artificial Sequence Synthetic peptide
YGGFL

SEQ ID NO: 20 - protein, 12 aa, Artificial Sequence
  Description of Artificial Sequence Synthetic peptide
EGEWTEGKLSLR

SEQ ID NO: 21 - protein, 12 aa, Artificial Sequence
  Description of Artificial Sequence Synthetic peptide
XGXWTXGKLSLR